(19) United States
(12) Patent Application Publication
(10) Pub. No.: US 2025/0315869 A1
(43) Pub. Date: Oct. 9, 2025

(54) MANAGING UTILITY BILLS AND OPTIMIZING UTILITY CONSUMPTION OF A UTILITY CONSUMPTION SITE

(71) Applicant: APPLIED ENERGY TECHNOLOGIES PRIVATE LIMITED, New Delhi (IN)

(72) Inventors: Shweta SINGH, New Delhi (IN); Ashok JUNEJA, New Delhi (IN)

(21) Appl. No.: 19/174,179

(22) Filed: Apr. 9, 2025

Related U.S. Application Data
(60) Provisional application No. 63/631,691, filed on Apr. 9, 2024.

(51) Int. Cl. G06Q 30/04; G05B 13/02; G06F 40/279; G06Q 50/06; G06V 10/774; G06V 30/10; G06V 30/41

(52) U.S. Cl. CPC G06Q 30/04; G05B 13/0265; G06F 40/279; G06Q 50/06; G06V 10/774; G06V 30/10; G06V 30/41; G06V 2201/02

(57) ABSTRACT

Approaches for managing utility bills and optimizing utility consumption in industrial environments are described. A utility bill resolution system automates extraction, parsing, analysis, and resolution of utility bills from utility providers. The system detects anomalies within bills using machine learning models and verifies bill authenticity using real-time consumption data. A utility consumption optimization system analyzes historical consumption data and utility rate information to generate optimized operation schedules for utility-intensive equipment and processes. The optimization system considers time-of-day pricing structures and implements peak shaving strategies to reduce costs. Both systems leverage advanced technologies including optical character recognition, natural language processing, and Internet of Things (IoT) devices to enhance accuracy and efficiency. The integrated approach enables industrial consumers to ensure billing accuracy, proactively optimize utility consumption patterns, and achieve significant cost savings while improving operational efficiency across multiple utility consumption sites.

### BACKGROUND

Utility services are provided to various utility consumption sites, such as telecommunication towers, commercial buildings, industrial facilities, and bank branches, to power components involved in their operation. These utility services are essential to maintain the uptime of these utility consumption sites. In return, the utility service provider charges users for the consumed utility by measuring the amount of utility used and preparing a utility bill accordingly. Such utility bill must be resolved on time, otherwise, the utility providers may impose penalties, or in some cases even disconnect the utility service, resulting in critical downtime causing service disruption and eventually uptime/revenue loss for these utility consumption sites.

Additionally, the charges or rates for utility consumption depend on the time of day, i.e., higher rates being charged by the utility providers during peak hours. These higher charges may significantly impact the operational costs of the sites. The charges or rates for utility consumption also depend on the energy consumption of these sites. Higher peak loads will be charged higher. (Electricity prices for large-scale consumers are often based on their maximum peak load)

### BRIEF DESCRIPTION OF FIGURES

Systems and/or methods, in accordance with examples of the present subject matter are now described and with reference to the accompanying figures, in which:

FIG. 1 illustrates an industrial environment comprising a utility bill resolution system and a utility consumption optimization system for resolving utility bill and for managing utility consumption, respectively, as per an example;

FIG. 2 illustrates a communication environment comprising a utility bill resolution system for utility bill management and resolution, as per an example;

FIG. 3 illustrates a detailed block diagram of a utility bill resolution system, as per an example;

FIG. 4 illustrates a training system for training an anomaly detection model and a meter image recognition model, as per an example;

FIG. 5 illustrates a method for performing utility bill management and resolution, as per an example;

FIG. 6 illustrates a method for training an anomaly detection model and a meter image recognition model, as per an example;

FIG. 7 illustrates a statistical distribution diagram showing the interquartile range (IQR) method for detecting outliers, including a box plot and normal distribution curve, as an example;

FIG. 8A-8B illustrates graph showing utility consumed and utility bill amount per month with outliers determined using interquartile range (IQR), as per an example;

FIG. 9A-9B illustrates graph showing utility consumed and utility bill amount per month with outliers determined using Mahalanobis distance, as per an example;

FIG. 10A-B illustrates histograms showing tariff change detection patterns for two different utility companies, highlighting periods of significant rate changes, as per an example;

FIG. 11 illustrates a user interface showing exception count for various utility billing parameters, including meter mismatch, bill deviations, and load-related anomalies, as per an example of the present subject matter;

FIG. 12 illustrates a dashboard interface for managing utility billing analytics and metrics, as per an example;

FIG. 13-14 depicts different Complete Automated Public Turing test to tell computers and Human Apart (CAPTCHA) verification interfaces used for human verification in web systems, as per an example;

FIG. 15 illustrates a physical utility bill to be analyzed by a utility bill resolution system for resolution, as per an example;

FIG. 16 illustrates example screenshots of a conversation related to utility bill between a utility bill resolution system and a customer, as per an example;

FIG. 17 illustrates recognition of value of an attribute by a meter image recognition model based on meter images, as per an example;

FIG. 18 illustrates a communication environment comprising a detailed block diagram of a utility consumption optimization system for optimizing operation of a utility consumption site, as per an example; and

FIG. 19 illustrates a method for optimizing operation of a utility consumption site, as per an example.

### DETAILED DESCRIPTION

The management of utility bills in industrial environments has become increasingly complex in recent years due to the growing scale of operations, diversification of utility types, and the intricate pricing structures employed by utility providers. Large-scale industrial facilities, data centers, telecommunication networks, and commercial complexes often consume substantial amounts of electricity, water, gas, and other utilities across multiple sites. This consumption is typically subject to variable rates, time-of-use pricing, demand charges, and various regulatory surcharges, resulting in highly detailed and complex billing structures.

Simultaneously, the advent of smart metering technologies, Internet of Things (IoT) devices, and advanced monitoring systems has led to an exponential increase in the volume and granularity of consumption data available to both utility providers and consumers. This wealth of data offers the potential for more accurate billing, real-time consumption monitoring, and opportunities for energy optimization. However, it also presents challenges in terms of data processing, analysis, and reconciliation with traditional billing systems.

The implementation of Time-of-Day (ToD) pricing and peak demand management it strategies has further complicated utility management in industrial settings. ToD pricing structures, which vary electricity rates based on the time of consumption, require sophisticated monitoring and control systems to optimize usage patterns. Similarly, peak shaving techniques, aimed at reducing maximum power demand during high-cost periods, necessitate real-time data analysis and rapid response capabilities. These strategies, while offering significant potential for cost savings, also introduce additional layers of complexity to billing structures and consumption management.

Furthermore, the regulatory landscape governing utility consumption and billing has become increasingly stringent and complex. Environmental regulations, energy efficiency mandates, and carbon reduction initiatives have introduced new requirements for reporting, verification, and compliance. These factors have collectively elevated the importance of accurate, timely, and verifiable utility bill management in industrial settings, making it a critical component of operational efficiency and cost control.

Despite these advancements and increasing complexities, many industrial entities continue to rely on conventional utility bill management systems that are ill-equipped to handle the challenges of the modern utility landscape. These traditional systems often involve manual data entry, basic spreadsheet-based analysis, and rudimentary rule checks that are prone to human error and inefficiency. They typically lack the sophistication to automatically extract data from diverse bill formats, reconcile billed amounts with real-time consumption data, or detect subtle anomalies that may indicate billing errors or opportunities for cost savings.

Moreover, these systems struggle to adapt to changing tariff structures, handle multi-site aggregations, or provide timely insights for energy optimization. Particularly challenging for conventional systems is the effective management of ToD pricing structures and the implementation of peak shaving strategies, which require dynamic, real-time analysis and decision-making capabilities. As a result, organizations face risks of overpayment, missed billing errors, compliance issues, and lost opportunities for cost reduction, while also failing to fully capitalize on potential savings from optimized ToD usage and effective peak demand management. This situation is further exacerbated by the dedication of significant human resources to time-consuming, error-prone manual processes, which could be better utilized in strategic energy management roles.

Approaches for managing utility bills and optimizing utility consumption in an industrial environment are described. In an example, the utility bill may be managed through a utility bill resolution system implemented within the industrial environment or at remote location. As may be understood, the industrial environment may include multiple utility consumption sites, such as manufacturing facilities, data centers, or commercial complexes. The utility bill resolution system (referred to as resolution system) is communicatively coupled to various entities including utility providers, utility consumption sites, and payment gateways through a network. The approaches as described enable automated extraction, parsing, analysis, and resolution of utility bills from utility bill generation platform which may be hosted by the utility providers. In addition, the present approaches also enable detection of anomalies within utility bills and verification of bill authenticity using real-time consumption data from utility consumption sites. The utility bill data may then be processed by one (or more) engine(s) that may be implemented within the utility bill resolution system. Once processed, various insights into the utility consumption patterns, billing accuracy, and potential cost-saving opportunities may be determined.

In operation, the resolution system may continuously or periodically, depending on the requirement, monitor a plurality of utility bill notification channels to detect the generation of new utility bills. In an example, the plurality of utility bill notification channels are sources which indicate that the concerned utility bill has been generated. Upon detection, the resolution system obtains the utility bill from a utility bill generation platform, parses it to determine values for a plurality of attributes related to utility usage and billing, and analyzes these values of the plurality of attributes to detect anomalies within the utility bill.

To do so, the resolution system may analyze the values of the plurality of attribute based on an anomaly detection model or based on a set of predefined rules. In an example, the anomaly detection model is trained using historical utility bills and may identify when attribute values of the concerned utility bill progress outside their normal ranges. On the other hand, the set of predefined rules includes various rules related to consumption threshold, expected ranges, typical usage pattern, etc. Based on the analysis, if no anomalies are detected within the utility bill, the resolution system facilitates generation of a signal for bill resolution. It may be noted that, this approach enables efficient, automated handling of utility bills while ensuring accuracy and detecting potential issues.

In addition to the above, a utility consumption optimization system (referred to as optimization system) for optimizing utility consumption and associated cost in utility consumption sites may also be implemented. In operation, the optimization system obtains historical utility consumption data and utility rate information, analyze this data to identify energy-intensive equipment or processes operating during high-rate periods, and generates an optimized operation schedule. In an example, the optimized schedule aims to reallocate operation of utility-intensive equipment and processes to lower-rate periods where operationally feasible. Further, the optimized schedule is to prioritize using energy from secondary energy sources during high-rate periods for powering different components of the utility consumption site. This approach enables industrial consumers to optimize their utility costs by taking advantage of time-of-use pricing structures and implementing effective load management strategies.

The present invention represents various technical advancements in utility bill management and energy optimization for industrial environments. By automating the entire process from bill detection to payment, and incorporating advanced anomaly detection and energy optimization techniques, the system improves efficiency, accuracy, and cost-effectiveness of utility management. The use of machine learning models allows the system to adapt to changing consumption patterns and billing structures over time. Furthermore, the system's ability to interface with various notification channels, handle complex authentication processes, and integrate real-time consumption data demonstrates its versatility and robustness in dealing with diverse utility management scenarios. This comprehensive approach enables industrial consumers to not only ensure billing accuracy but also proactively optimize their utility consumption patterns, leading to significant cost savings and improved operational efficiency.

The explanation provided above, and the examples discussed in the current description are exemplary only. For instance, while some examples may describe obtaining a single utility bill corresponding to a utility consumption site, the current approaches are applicable for other scenarios as well, such as analyzing more than one utility bill corresponding to a group of utility consumption site, without deviating from the scope of the present subject matter.

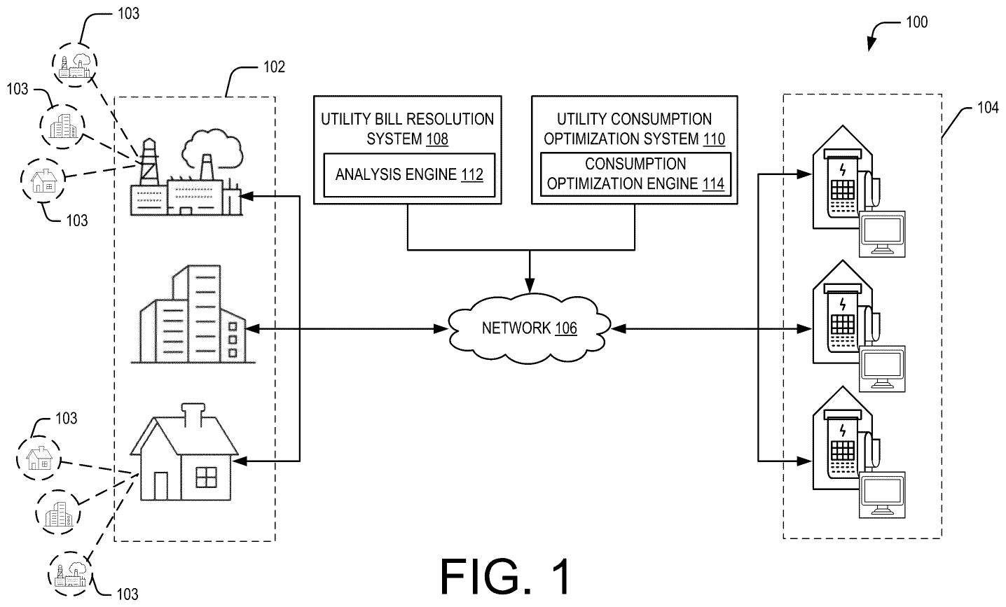

The manner in which the utility bill resolution system and the utility consumption optimization system are used for resolving bills and utility consumption optimization, respectively, is explained in detail with respect to FIGS. 1-18. While aspects of described systems may be implemented in any number of different electronic devices, environments, and/or implementation, the examples are described in the context of the following example device(s). In another example, the aspects of the present subject matter may also be implemented by a standalone device having executable instructions. It may be noted that drawings of the present subject matter shown here are for illustrative purposes and are not to be construed as limiting the scope of the subject matter claimed.

FIG. 1 illustrates an industrial environment 100 encompassing various entities for resolving utility bill and optimizing utility consumption across various utility consumption sites, in accordance with one example of the present subject matter.

The industrial environment 100 (referred to as environment 100) includes several interconnected entities, each playing an important role in the overall utility management and resolution ecosystem. Examples of various entities involved in the environment 100 include, but are not limited to, utility consumption sites 102, utility providers 104, a utility bill resolution system 108, and a utility consumption optimization system 110.

In an example, the utility consumption sites 102 represent various facilities that consume different types of utilities. These may include manufacturing plants, data centers, telecommunication towers, commercial buildings, or any other industrial or commercial establishments. For example, the utility consumption sites 102 may include a factory in City A, a collection of buildings in City B, and houses in City C. Although, in FIG. 1, only three sites are shown, embodiments are not limited thereto, and there may be more or fewer sites for each user or facility manager or customer. It may be noted that, these sites may consume various types of utilities such as electricity, water, natural gas, steam, or specialized industrial gases. The facilities at these sites may house production equipment, Heating, ventilation and air conditional (HVAC) systems, lighting, computing infrastructure, or other utility-consuming assets essential for their operations.

In some embodiments, each of the utility consumption sites 102 (referred to as sites 102) may include an edge device, such as an Internet of Things (IoT) edge device to collect data from one or more sensors implemented at the site. In some embodiments, the IoT edge device may comprise or be connected to one or more sensors and is capable of obtaining sensor data via internal sensors. Based on the real time data collected from the different sensors, the IoT edge device may create real time feeds at regular intervals or continuously. Alternatively or additionally, the IoT edge device may create feeds on occurrence of events, such as when sensor data shows anomalous behavior associated with one or more batteries, power lines, or other components associated with the environment 100.

Examples of the sensors may include, but are not limited to, a proximity sensor, a pressure sensor, a humidity sensor, and a level sensor. In some embodiments, the sensor may include an electrical characteristics sensor, which may be configured to detect one or more specific parameters, such as voltage, electric current, electrical resistance, electrical reactance, electrical charge, partial discharge, electrical power, magnetic flux, magnetic field, etc. Various types of sensors may be utilized to measure the electrical characteristics of the electricity usage in the sites, for example, electricity meter, electrometer, Hall effect sensor, etc. In some embodiments, one edge device is connected to one site. In some embodiments, a plurality of edge devices are connected to one site.

In addition, each utility consumption site 102 may include a plurality of tenant consumption sites 103. These tenant consumption sites 103 represent individual entities or operators that share the infrastructure and resources of the main utility consumption site 102. For example, in a telecommunication tower scenario, multiple telecom operators may have their equipment installed as separate tenant consumption sites 103 within the same tower facility. Each tenant consumption site 103 may have its own unique utility consumption profile and utility usage patterns, which are monitored and managed individually by the system while also being integrated into the overall utility management of the consumption site 102.

Utilities for these consumption sites are provided by various utility providers 104, represented in the environment 100 by an entity involving usage of computer systems. Examples of utility providers may include, but are not limited to, electric companies, water supply corporations, natural gas distributors, or specialized industrial utility suppliers. The utilities provided may have complex pricing structures, including time-of-use rates, demand charges, seasonal variations, and various surcharges or taxes.

In view of the utility consumption at the utility consumption sites 102, the utility providers 104 generate utility bills corresponding to each utility consumption site. These bills typically include detailed information about usage quantities, applicable rates, total charges, and may also contain historical consumption data, rate change notifications, or other relevant information.

To efficiently manage these utility bills and optimize the consumption of utilities, two systems are implemented within the environment 100, namely, the utility bill resolution system 108 and the utility consumption optimization system 110. In an example, the utility bill resolution system 108 includes an analysis engine 112 designed to process and analyze utility bills. The utility bill resolution system 108 is responsible for tasks such as automated bill data extraction, validation of charges, detection of billing anomalies, and facilitation of timely resolution. The analysis engine 112 may use along with advanced algorithms, machine learning techniques, and rule-based processing to scrutinize bill details and identify potential errors or opportunities for cost savings.

On the other hand, the utility consumption optimization system 110 incorporates an optimization engine 114 focused on analyzing consumption patterns and identifying opportunities for energy efficiency and cost reduction. The utility consumption optimization system 110 may analyze real-time consumption data, historical consumption data, and utility rate information to suggest optimal operational strategies. It may also be responsible for implementing demand response programs, managing peak load reduction initiatives, and ensuring compliance with energy efficiency regulations.

All these components within the environment 100 are interconnected via a network 106. This network facilitates communication and data exchange between the utility consumption sites 102, the computer system of the utility providers 104, the utility bill resolution system 108, and the utility consumption optimization system 110. Such network 106 enables real-time data transmission, remote monitoring capabilities, and seamless integration of various data sources and analytical tools.

In an example, the network 106 may be a private network or a public network and may be implemented as a wired network, a wireless network, or a combination of a wired and wireless network. The network 106 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

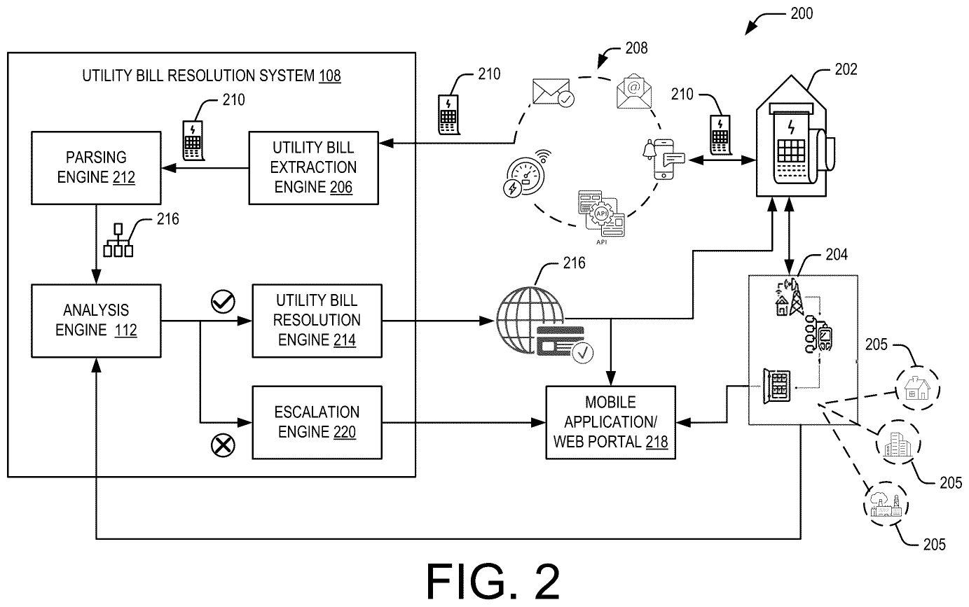

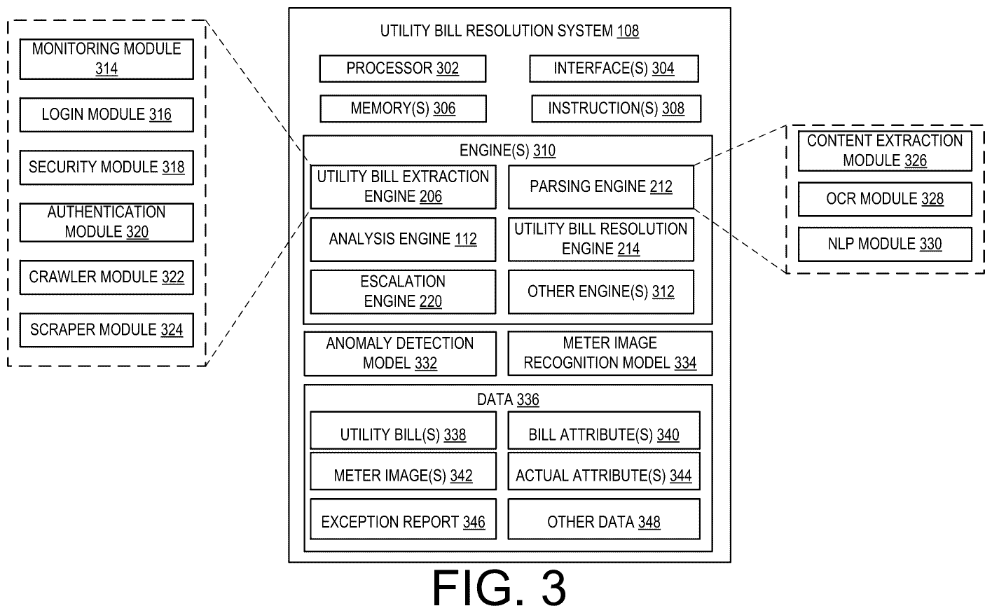

The detailed manner in which the utility bill resolution system 108 extract and analyze bills is described in conjunction with FIGS. 2-3, providing a more comprehensive understanding of the system's functionality and capabilities.

FIG. 2 illustrates a communication environment 200 including a utility bill resolution system 108 for utility bill management and resolution, in accordance with one example of the present subject matter. FIG. 2 illustrates communication of utility bill resolution system 108 (referred to as resolution system 108) with various components or entities involved within the utility bill management and resolution. All communications between entities in this communication environment 200 are facilitated by a network (not shown in FIG. 2), which may include local area networks, wide area networks, the internet, or a combination thereof.

The communication environment 200 includes a utility provider 202 which is configured to provide utility services to a utility consumption site 204 via various distribution networks such as power grids, water supply systems, or gas pipelines. Examples of utility consumption site 204 may include, but are not limited to, industrial facilities, commercial buildings, data centers, or telecommunication towers, equipped with various utility consuming equipment and systems such as manufacturing machinery, HVAC systems, servers, or telecommunication equipment.

In addition, the utility consumption site 204 may include a plurality of tenant consumption sites 205. These tenant consumption sites 205 represent individual entities or operators that share the infrastructure and resources of the main utility consumption site 204. For example, in a telecommunication tower scenario, multiple telecom operators may have their equipment installed as separate tenant consumption sites 205 within the same tower facility. Each tenant consumption site 205 may have its own unique utility consumption profile and utility usage patterns, which are monitored and managed individually by the system while also being integrated into the overall utility management of the consumption site 204.

Since utility provider 202 provides utility services to the utility consumption site 204, it may generate utility bills periodically depending on their schedule for charging for the utility consumed. To manage and resolve such utility bills, the communication environment 200 includes the resolution system 108 which incorporates various engines for monitoring, extracting, parsing, analysis, and resolution of the utility bills. In an example, the resolution system 108 includes a utility bill extraction engine 206 for monitoring generation of bills and subsequently extract them.

In one example, the utility bill extraction engine 206 (referred to as extraction engine 206) includes various modules (which are explained in detail in conjunction with FIG. 3) for various purposes, such as monitoring, login, crawling, authentication, etc. To detect generation of the utility bills, the extraction engine 206 continuously or periodically monitors various utility bill notification channels 208 (referred to as channels 208). Examples of such channels 208 include, but are not limited to, Short Message Service (SMS) notifications from the utility provider 202, email notifications, mobile application push notifications, utility company website bill generation alerts, Application Programming Interface (API) notifications from the utility company's billing system, and smart meter data feeds indicating completion of a billing cycle. On detecting generation of a utility bill, one or more modules of the extraction engine 206 collectively extracts a utility bill 210 from a utility bill generation platform via one of the channels 208, wherein the utility bill generation platform is hosted by the utility provider 202.

The resolution system 108 further includes a parsing engine 212 which is configured to parse the extracted utility bill 210 to determine values of a plurality of attributes related to utility usage and billing. Examples of such attributes include, but are not limited to, utility consumption data, billing amount, tariff levied details, due date, meter identification number, customer information, billing period, rate schedules, special charges, historical consumption data, payment history, and utility provider information.

Once extracted, the resolution system 108 includes an analysis engine, such as analysis engine 112, for analysis of the utility bill to detect anomalies within the utility bill indicating progression of values of at least one of the plurality of attributes outside normal ranges. The analysis may be done based on a machine learning model or a set of predefined rules. The machine learning model may be an anomaly detection model trained based on a plurality of training utility bills, with each training utility bill comprising a training value corresponding to the plurality of attributes and a corresponding training indicator indicating normal and anomalous status of the training utility bill.

On the other hand, the predefined rules may include consumption thresholds for different time periods, expected ranges for billing amounts based on historical data, permissible variations in meter readings between consecutive billing cycles, typical usage patterns for different customer categories, seasonal adjustments for utility consumption, predefined limits for sudden spikes or drops in usage, expected ratios between different utility services for multi-utility bills, compliance with tariff structures and rate plans, consistency between reported consumption and calculated charges, and alignment with regulatory guidelines for utility billing.

Based on the analysis, upon determining that the utility bill does not include any anomaly, the utility bill 210 is transferred to a utility bill resolution engine 214 for resolution of the bill. The utility bill resolution engine 214 (referred to as resolution engine 214) is to connect with a payment gateway 216 for resolution or payment of the utility bill 210. During resolution, the resolution engine 214 via the payment gateway 216 transmits a permission or approval request on a mobile application/web portal 218 (referred to as application 218) for approval. Once approved, the resolution status is transferred to utility provider 202.

On the other hand, upon determining an anomaly within the utility bill 210, the utility bill 210 is transferred to the escalation engine 220 for further investigation and resolution. In an example, the escalation engine 220 is to generate and escalate an exception report indicating the anomaly detected within the utility bill 210 to one or more stakeholders for review and resolution. In one example, the escalation engine 220 transfers the exception report to the application 218 to be displayed before the concerned stakeholder.

In addition to the detection of anomalies within the utility bill, the analysis engine 112 may also check correctness of the utility bill by receiving real-time consumption data from utility consumption site 204. For example, the analysis engine 112 may compare the values of the plurality of attributes determined from the utility bill 210 with respect to the values obtained from a plurality of monitoring devices installed within the utility consumption site 204, where the plurality of monitoring devices comprises IoT devices and sensors. Based on this comparison, the analysis engine 112 may determine the correctness of the utility bill, providing an additional layer of verification to ensure accurate billing and consumption tracking (The detailed explanation regarding the manner in which the utility bill resolution system resolves the utility bill is further explained in detail in conjunction with FIG. 3).

FIG. 3 illustrates a detailed block diagram of a utility bill resolution system, such as resolution system 108, as per an example of the present subject matter. The resolution system 108 may include a processor 302, interface(s) 304, and memory(s) 306. The processor 302 may be implemented as microprocessors, microcomputers, microcontrollers, digital signal processors, central processing units, state machines, logic circuitries, and/or other devices that manipulate signals based on operational instructions. Among other capabilities, the processor 302 may be configured to obtain a utility bill, such as utility bill 210, corresponding to the utility consumption site 204 that is being analyzed for determining anomaly indicating inconsistencies. The processor 302 may then use the analysis engine 112 to detect anomalies within the utility bill 210. In an example, the processor 302 may also be capable of determining correctness of the utility bill 210 by comparing the details of the utility bill 210 with the details obtained from the images of the meter obtained from onsite meters and consumption readings obtained from IoT devices and sensors installed on utility consumption site 204.

The interface(s) 304 may allow the connection or coupling of the resolution system 108 with one or more data repositories through a wired network, a wireless network, or a combination of a wired and wireless network. The interface(s) 304 may also enable intercommunication between different logical as well as hardware components of the resolution system 108.

The memory(s) 306 may be a computer-readable medium, examples of which include volatile memory (e.g., RAM), and/or non-volatile memory (e.g., Erasable Programmable read-only memory, i.e., EPROM, flash memory, etc.). The memory(s) 306 may be an external memory, or internal memory, such as a flash drive, a compact disk drive, an external hard disk drive, or the like. The memory(s) 306 may further include data which either may be utilized or generated during the operation of the resolution system 108.

The resolution system 108 may further include instruction(s) 308 and engine(s) 310. In an example, the instruction(s) 308 are fetched from the memory(s) 306 and executed by the processor 302 included within the resolution system 108. The engine(s) 310 may include the analysis engine 112, along with other engines, namely, extraction engine 206, parsing engine 212, resolution engine 214, escalation engine 220, and other engine(s) 312.

All of the above-mentioned engines may be implemented as a combination of hardware and programming, for example, programmable instructions to implement a variety of functionalities. In examples described herein, such combinations of hardware and programming may be implemented in several different ways. For example, the programming for the engine(s) 310 may be executable instructions, such as instruction(s) 308. Such instruction(s) 308 may be stored on a non-transitory machine-readable storage medium which may be coupled either directly with the resolution system 108 or indirectly (for example, through networked means).

In an example, each of the engine(s) 310 may include a processing resource, for example, either a single processor or a combination of multiple processors, to execute such instructions. For example, the utility bill extraction engine 206 includes a monitoring module 314, a login module 316, a security module 318, an authentication module 320, a crawler module 322, a scraper module 324, amongst others. Further, the parsing engine 212 may include a content extraction module 326, a Optical Character Recognition (OCR) module 328, and a Natural Language Processing (NLP) module 330. In the present examples, the non-transitory machine-readable storage medium may store instructions, such as instruction(s) 308, that when executed by the processing resource, implement the various engine(s) 310. In another examples, the engine(s) 310 may be implemented as electronic circuitry. It may be noted that, other engines as comprised within the engine(s) 310 may also include various modules without deviating from the scope of the present subject matter.

The resolution system 108 may further include one or more machine learning models, such as an anomaly detection model 332 and a meter reading recognition model 334, and a data 336. The data 336 may include data that is utilized or generated by the resolution system 108, while performing a variety of functions. In an example, the data 336 further includes utility bill(s) 338, bill attribute(s) 340, meter image(s) 342, actual attribute(s) 344, exception report 346, and other data 348. Further, the other data 348, amongst other things, may serve as a repository for storing data that is processed, or received, or generated as a result of the execution of the instructions by the processor 302.

In operation, initially, the extraction engine 206 obtains one or more utility bills corresponding to a plurality of utility consumption sites, such as sites 102 or site 204 from a utility bill generation platform. In an example, the monitoring module 314 of the extraction engine 206 may continuously monitors a plurality of utility bill notification channels, such as channels 208, to detect generation of the utility bill(s) 338. Examples of channels 208 include, but are not limited to, SMS notifications sent directly from utility companies, email notifications to registered customer accounts, mobile application push notifications for customers who have installed the utility company's app, utility company website bill generation alerts that may be scraped or accessed via API, direct API notifications from utility company billing systems, and smart meter data feeds that indicate the completion of a billing cycle.

When the monitoring module 314 detects the generation of a new utility bill, such as utility bill 210, by a utility provider 202 corresponding to the monitored utility consumption site, the extraction engine 206 initiates the bill extraction process. The process of extraction of utility bill may vary depending on the notification channel through which the bill availability was detected. For example, for SMS or email notifications, the extraction engine 206 may parse the message content to identify bill download links or login instructions. For website alerts or API notifications, the extraction engine 206 may directly initiate a connection to the utility provider's system.

In an example, the extraction engine 206 includes various modules which helps to extract the utility bill. For example, the login module 316 implements the authentication process required to access the utility bill generation platform. The login module 316 may maintain a secure database of stored authentication credentials for each utility provider and consumption site. These credentials may include usernames, passwords, account numbers, and any additional authentication factors that may be required by the utility provider. In an example, the login module 316 may also implement encryption and secure storage practices to protect credentials.

Once the login module 316 initiates the authentication process, the security module 318 comes into play to handle any additional security challenges presented by the utility bill generation platform. One of the common security measures encountered is CAPTCHA verification, designed to prevent automated access. The security module 318 employs advanced machine learning-based image recognition techniques to identify and solve these challenges. For image-based CAPTCHAs, the security module 318 may use convolutional neural networks trained on large datasets of CAPTCHA images to recognize and select the required elements, such as street signs, vehicles, or storefronts. For text-based CAPTCHAs, the module may utilize optical character recognition (OCR) in combination with text distortion correction algorithms to decipher the presented characters.

After successfully navigating any initial security challenges, many utility providers implement multi-factor authentication as an additional security layer. To cater this, the extraction engine 206 includes the authentication module 320. For example, on resolving the security challenges, the resolution system 108 may receive authentication codes through various channels, such as SMS, email, or dedicated authentication applications. The authentication module 320 may retrieve these codes from the designated channel and input them into the utility provider's system. In cases where manual input is required, the authentication module 320 queue the authentication request for human intervention, ensuring that the automated process may continue with minimal delay.

Upon successful completion of multi-factor authentication, the crawler module 322 takes over to navigate the user interface of the utility bill generation platform. In an example, the crawler module 322 may employ web scraping techniques to traverse the website's structure, following links and interacting with elements to locate the specific page or section where the utility bill is available. Once the crawler module 322 has located the utility bill(s) 338, the scraper module 324 is activated to download the bill. The scraper module 324 may handle various file formats, including Portable Document Format (PDF), Hyper Text Markup Language (HTML), Comma Separated Values (CSV), or proprietary formats used by specific utility providers. The scraper module 324 may employ different techniques depending on the file format, such as direct download for PDF files, HTML parsing for web-based bills, or API calls for providers that offer programmatic access to billing data. The scraper module 324 may also handle any compression or encryption applied to the bill files, ensuring that the downloaded content is in a format ready for further processing.

Once the utility bill 210 is successfully downloaded, it is stored as utility bill(s) 338 in data 336 in the resolution system 108. Thereafter, the utility bill(s) 338 is transferred to the parsing engine 212 for further processing. For example, the parsing engine 212 begins the process of extracting relevant information from the utility bill(s) 338. In an example, the context extraction module 326 of the parsing engine 212 may first determine the structure and format of the bill, which may vary significantly between utility providers. It may identify key sections of the bill, such as the summary, detailed usage breakdown, and payment information.

Thereafter, the OCR module 328 is then employed to convert any image-based or scanned bill components into machine-readable text. The OCR module 328 may use advanced OCR algorithms capable of handling various fonts, layouts, and potential image distortions. It may also incorporate pre-processing steps such as image de-skewing, noise reduction, and contrast enhancement to improve recognition accuracy.

Once the bill content is in text format, the NLP module 330 processes this text to identify and categorize information corresponding to the plurality of attributes required for analysis and store the identified values as bill attribute(s) 340 in the data 336 of the resolution system 108. In an example, the NLP module 330 may employ techniques such as named entity recognition to identify specific types of information (e.g., dates, monetary amounts, meter numbers), part-of-speech tagging to understand the structure of sentences and phrases, and semantic analysis to interpret the meaning and context of extracted information.

The bill attribute(s) 340 extracted from the utility bill(s) 338 may include, but are not limited to:
Utility consumption data: This may include total kilowatt-hours (kWh) consumed, peak demand in kilowatts (kW), and time-of-use breakdowns if applicable.
Billing amount: The total amount due, often broken down into various components.
Tariff levied details: Information on the rate structure applied, including base rates, tiered pricing, or time-of-use rates.
Due date: The date by which payment must be made to avoid late fees or service interruption.
Meter identification number: A unique identifier for the meter associated with the consumption site.
Customer information: Name, account number, service address.
Billing period: Start and end dates for the current billing cycle.
Rate schedules: Detailed breakdown of rates applied for different consumption levels or times.
Special charges or credits: Any one-time fees, discounts, or adjustments applied to the bill.
Historical consumption data: Comparison of current usage to previous periods or year-over-year analysis.
Payment history: Record of previous payments and any outstanding balances.
Utility provider information: Contact details, emergency numbers, and regulatory information.

Once the utility bill(s) 338 is parsed and bill attribute(s) 340 are determined, the analysis engine 112 begins its analytical process to detect anomalies within the utility bill(s) 338. In an example, the analysis engine 112 may perform this analytical assessment based on a machine learning model, such as anomaly detection model 332, or based on a set of predefined set of rules (not shown in FIG. 3).

In case of assessment based on the anomaly detection model 332, the analysis engine 112 may analyze the values comprised within the bill attribute(s) 340 based on the anomaly detection model 332 to detect anomalies indicating progression of values of at least one of the plurality of attributes outside normal ranges corresponding to that attribute. In an example, the anomaly detection model 332 may be a machine learning model, trained potentially based on techniques such as isolation forests, autoencoders, or ensemble methods combining multiple anomaly detection approaches. In one example, the anomaly detection model 332 is trained based on a plurality of training utility bills, with each training utility bill comprising a training value corresponding to the plurality of attributes and a corresponding training indicator indicating normal and anomalous status of the training utility bill.

The anomaly detection model 332 may employ several strategies to identify anomalies, including statistical analysis, time series analysis, and correlation analysis. For statistical analysis, the anomaly detection model 332 compares each attribute value to its historical distribution, flagging values that fall outside a certain number of standard deviations from the mean. Further, for time series analysis, the anomaly detection model 332 examines the progression of values over time to detect sudden changes or deviations from established patterns. Lastly, correlation analysis checks for expected relationships between different attributes (e.g., consumption and cost) and flags instances where these relationships are violated.

The analysis engine 112 may detect various types of anomalies using this model, including unusual utility consumption patterns, discrepancies between billed amounts and actual consumption data, incorrect tariff levied, billing errors, and meter reading inconsistencies. For example, unusual utility consumption patterns might include sudden spikes or drops in usage that may not be explained by seasonal variations or known changes in the consumption site's operations. Further, discrepancies between billed amounts and actual consumption data may be cases where the billed amount does not align with the reported energy usage based on established rate structures. Incorrect tariff levied might be instances where the applied rate structure does not match the expected tariff for the customer's category or contracted terms. Billing errors may include computational mistakes in the bill calculation, such as incorrect multiplication of rates and consumption or errors in summing up charges. Meter reading inconsistencies might be discrepancies between the billed consumption and readings from on-site meters or IoT devices.

By leveraging the anomaly detection model 332, the analysis engine 112 may efficiently process large volumes of utility bills, identifying potential issues that may require further investigation or corrective action. This automated approach significantly reduces the manual effort required for bill verification and helps ensure accuracy in utility billing and consumption tracking.

To enhance the accuracy of anomaly detection, in another example, the analysis engine 112 may also analyze the determined bill attribute(s) 340 based on a set of predefined rules (not shown in FIG. 3). In an example, the analysis engine 112 may apply logical conditions to determine whether the values of the bill attribute(s) 340 are conformant with the criteria outlined in the set of predefined rules.

In an example, the predefined set of rules encompass a wide range of checks to ensure comprehensive bill verification. For example, the predefined set of rules include:
Consumption thresholds that are established to flag bills where usage exceeds or falls below expected ranges for different time periods, taking into account factors like seasonality and historical usage patterns.
Expected billing ranges that are used to identify bills where the total amount falls outside anticipated ranges based on historical data and known rate changes. In this case, the analysis engine 112 checks for logical progression of meter readings between consecutive billing cycles, flagging cases of meter rollback or implausible jumps in readings.
Usage patterns that are analyzed against typical profiles for the customer's category (e.g., residential, commercial, industrial), with significant deviations being flagged for review.
Seasonal adjustments are accounted for, ensuring that bills align with expected seasonal variations in utility consumption. The system identifies abrupt changes in consumption or billing amounts that exceed predefined thresholds for month-to-month or year-over-year variations. For sites with multiple utility services, the system checks for expected ratios between different services (e.g., electricity vs. gas consumption) and flags inconsistencies.
Tariff compliance is verified to ensure that applied rates and charges comply with the latest approved tariff structures and any special rate plans applicable to the customer. The system crosschecks the consistency between reported consumption, applied rates, and calculated charges to ensure charge calculation accuracy. Additionally, regulatory compliance is ensured by verifying that the bill structure and charges align with current regulatory guidelines for utility billing in the relevant jurisdiction.

As an additional verification step, the analysis engine 112 compares the values extracted from the utility bill, i.e., the bill attribute(s) 340 against data obtained from on-site meters and monitoring devices. This process involves several steps, including image acquisition, image processing, feature extraction, digit recognition, reading interpretation, and confidence scoring.

In an example, firstly, in case of analysis based on data obtained from on-site meters, the analysis engine 112 obtains one or more meter image(s) 342 indicating consumption readings of meters installed on the utility consumption site 204. In an example, the meter image(s) 342 are captured by a field engineer which is present in the utility consumption site 204 and upload the images to a data repository. The analysis engine 112 then obtains or retrieves these meter image(s) 342 from the data repository. Once obtained, the analysis engine 112 process the meter image(s) 342 of the utility meter based on the meter image recognition model 334 to extract the actual values of the plurality of attributes and stored them as actual attribute(s) 344 in the resolution system 108. Based on the extracted actual attribute(s) 344, the analysis engine 112 analyze the bill attribute(s) 340 to verify correctness of the utility bill(s) 338.

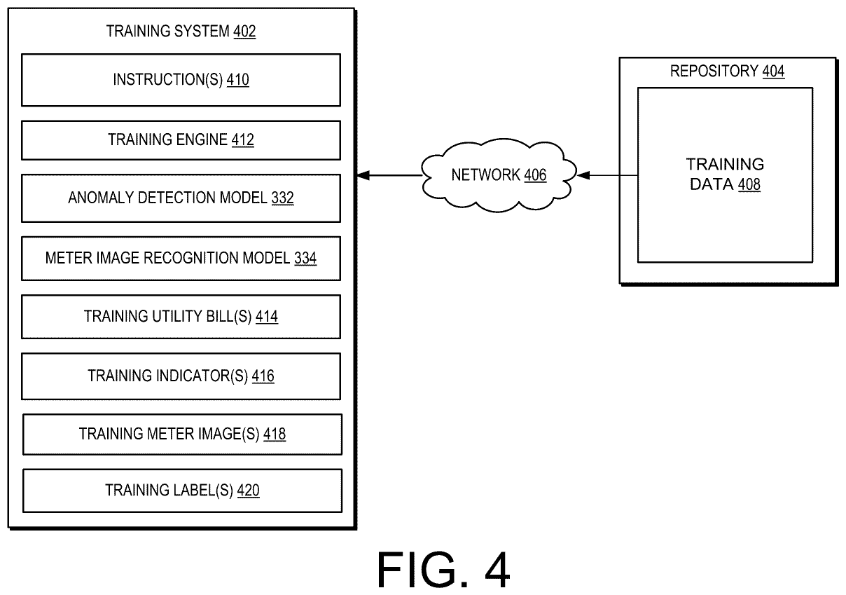

In an example, the meter image recognition model 334 is trained based on a diverse dataset of training meter images of utility meter and associated training labels indicating location of presence of various attributes on the image of the utility meter (The training process of anomaly detection model 332 and the meter image recognition model 334 is described in detail in conjunction with FIG. 4).

In parallel, the analysis engine 112 also collects data from IoT devices and sensors installed at the utility consumption site, such as sites 102 or 204, including smart power monitors, flow meters, environmental sensors, and production line sensors in industrial settings. The data from these devices is collected through various protocols, and the analysis engine 112 handles different data formats, sampling rates, and potential connectivity issues. With data collected from the utility bill, meter images, and IoT devices, the analysis engine 112 performs a comprehensive comparison. This involves aligning timestamps and measurement periods, converting units if necessary, applying calibration factors or offsets, and calculating expected relationships between different measurements. The comparison process uses statistical techniques to account for measurement uncertainties and normal fluctuations, considering known factors that may cause discrepancies.

Based on the assessment, if significant discrepancies or anomalies are detected, the analysis engine 112 generates the exception report 346, which includes a summary of the detected anomaly, relevant data points, historical context, visualizations, potential explanations, and recommended actions. The exception report 346 is then passed to the escalation engine 220, which determines the appropriate routing, assigns priority levels, identifies responsible personnel, determines communication channels, and sets deadlines for resolution. In an example, the escalation engine 220 also implements a workflow for tracking the status of escalated issues, including logging actions, sending reminders, and generating summary reports.

On the other hand, for utility bill(s) 338 that pass all checks without triggering anomalies, the resolution engine 214 initiates the bill resolution process via the payment gateway 216, which may involve verifying funds, initiating automated payments, updating accounting systems, generating payment confirmations, and updating bill status. In an example, analysis engine 112 generate a control signal to be transferred the resolution engine 214 for resolution of the utility bill. Throughout these processes, the resolution system 108 continuously updates and maintains its data stores, enabling various secondary functions such as trend analysis, performance evaluation, audit trails, and data for refining machine learning models.

In another example, the resolution system 108 may be configured to handle prepaid billing processes for smart meters. In this scenario, an online wallet may be maintained for each utility consumption site. The resolution engine 214 may include various modules (not shown in FIG. 2) that continuously track these online wallets, with each consumption site potentially having a distinct wallet. The login process for accessing these wallets may be similar to that used for postpaid billing, followed by crawling and scraping operations to retrieve wallet-related data such as current balance.

The resolution engine 214 may generate alerts when a wallet balance falls below a predetermined threshold. This threshold may be a fixed amount or an intelligent, consumption-based level. Upon detecting a low balance, the system may automatically initiate a wallet recharge process. If a wallet balance reaches zero, the utility services at the corresponding consumption site may be automatically suspended until payment is added to the wallet.

While month-end bills may still be generated for sites using prepaid smart meters, these bills may serve primarily as records of monthly usage rather than payment requests. The resolution system 108 may process and store these usage records, potentially using them for trend analysis and consumption forecasting. This approach may allow for proactive management of utility resources and more accurate predictions of future wallet recharge requirements.

In addition to managing utility bills for consumption sites, the utility bill resolution system 108 and utility consumption optimization system 110 are designed to handle complex multi-tenant scenarios in utility consumption sites. In cases where multiple tenants, such as different telecom operators, share a single utility consumption site like a telecom tower, the systems provide comprehensive management of utility usage and billing. The resolution system 108 integrates with IoT devices installed at the consumption site to gather precise load and usage data for each tenant. This granular data collection enables accurate disaggregation of utility consumption among multiple tenants sharing the same infrastructure.

The analysis engine 112 processes this disaggregated data to allocate utility costs to each tenant based on their specific consumption patterns. It calculates pro-rata shares of the overall utility bill, ensuring fair and transparent billing for all tenants. The utility bill resolution engine 214 then generates tenant-specific invoices, detailing individual usage and corresponding charges. This feature allows the utility consumption site's managing company to efficiently bill each tenant for their portion of the utility usage, streamlining the financial management of shared infrastructure.

Furthermore, the utility consumption optimization system 110 extends its capabilities to optimize energy usage not just for the overall site, but for individual tenants as well. By analyzing tenant-specific consumption patterns, the optimization engine 114 can provide tailored recommendations to each tenant for improving energy efficiency. This granular approach to optimization enables each tenant to reduce their energy costs while contributing to the overall efficiency of the utility consumption site. The system's ability to handle multi-tenant scenarios adds significant value to the utility management process, addressing the complex billing and optimization needs of shared infrastructure environments.

The resolution system 108 operates continuously, processing new bills as they are received and performing periodic batch analyses. By automating these complex processes, the system significantly reduces manual effort, improves accuracy in bill verification, and enables proactive management of utility consumption and costs. This leads to substantial cost savings, improved energy efficiency, and better compliance with energy management policies and regulations.

FIG. 4 illustrates a training system 402 including a processor and memory (not shown), for training models which are included within a utility bill resolution system. The training system 402 (referred to as system 402) may be communicatively coupled to a repository 404 through a network 406. The repository 404 may include training data 408. The training data 408 may include a plurality of training utility bills and associated data that may be used for training the utility bill management models. In an example, the training utility bills include bills which are associated with both normal and anomalous billing attributes. These training utility bills may encompass a wide range of scenarios, including various types of utilities (e.g., electricity, water, gas), different billing structures, seasonal variations, and diverse consumption patterns across multiple industrial and commercial settings.

In another example, along with plurality of training utility bills, the training data 408 may further include training indicators corresponding to each of the plurality of training utility bills. These indicators may denote whether a particular bill is normal or anomalous. The training indicators may be defined based on expert analysis, historical data, or predetermined criteria for identifying billing anomalies. Since this training data is used for training multiple machine learning models, the training data 408 may also include a plurality of training meter images of utility meter and associated training labels indicating location of presence of various attributes on the corresponding training meter image of the utility meter.

Although depicted as being obtained from a single repository, such as repository 404, the training data 408 may also be obtained from multiple other sources without deviating from the scope of the present subject matter. In such cases, each of such multiple repositories may be interconnected through a network, such as network 406.

The network 406 may be a private network or a public network and may be implemented as a wired network, a wireless network, or a combination of a wired and wireless network. The network 406 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The system 402 may further include instructions 410 and a training engine 412. In an example, the instructions 410 are fetched from the memory and executed by the processor included within the system 402. The training engine 412 may be implemented as a combination of hardware and programming, for example, programmable instructions to implement a variety of functionalities. In examples described herein, such combinations of hardware and programming may be implemented in several different ways. For example, the programming for the training engine 412 may be executable instructions, such as instructions 410. Such instructions may be stored on a non-transitory machine-readable storage medium which may be coupled either directly with the system 402 or indirectly (for example, through networked means). In an example, the training engine 412 may include a processing resource, for example, either a single processor or a combination of multiple processors, to execute such instructions. In the present examples, the non-transitory machine-readable storage medium may store instructions, such as instructions 410, that when executed by the processing resource, implement training engine 412. In other examples, the training engine 412 may be implemented as electronic circuitry.

The instructions 410, when executed by the processing resource, cause the training engine 412 to train an anomaly detection model, such as anomaly detection model 332 and a meter image recognition model, such as meter image recognition model 334 based on the training data 408. The system 402 may further include a training utility bill(s) 414, training indicator(s) 416, training meter image(s) 418, and a training label(s) 420. In an example, the training engine 412 of the system 402 may obtain training data 408 corresponding to a single training utility bill from the repository 404, and the information pertaining to that is stored as training utility bill(s) 414 and training indicator(s) 416 in the system 402. Further, the training engine 412 of the system 402 may obtain training data 408 corresponding to a single training meter image from the repository 404, and the information pertaining to that is stored as training meter image(s) 418 and training label(s) 420 in the system 402.

The anomaly detection model 332 is trained using the training utility bills 414 and their corresponding training indicators 416. In an example, the training engine 412 obtains training data 408 from the repository 404 including training utility bill(s) 414 and their corresponding training indicator(s) 416. In an example, each of the training utility bill comprised within the training utility bill(s) 414 includes a training value corresponding to the plurality of attributes which are related to utility usage and billing. Examples of such attribute include but are not limited, utility consumption data, billing amount, tariff levied details, due date, meter identification number, customer information, billing period, rate schedules, special charges, historical consumption data, payment history, and utility provider information. Further, the training indicator(s) 416 include status details of each of the training utility bill(s) 414 indicating either normal or anomalous status of the utility bill.

Once obtained, the training engine 412 trains the anomaly detection model 332 based on the training data. In an example, the anomaly detection model 332, when trained, is capable of detecting anomalies within utility bills by analyzing various attributes and identifying when their values progress outside normal ranges. The training process may involve techniques such as supervised learning, where the anomaly detection model 332 to associate values of specific bill attributes with normal or anomalous labels indicators, or unsupervised learning methods like clustering or autoencoders to identify outliers in the data.

Further, the training engine 412 obtains training data 408 from the repository 404 including training meter image(s) 418 and their associated training label(s) 420. In an example, the training meter image(s) 418 include images of utility meter captured from various angles, with varied illumination, with varied quality of cameras, etc. Further, the training label(s) 420 include details corresponding to each training meter image(s) 418 indicating location of presence of various attributes of the utility bill.

Once obtained, the training engine 412 trains the meter image recognition model 334 based on the training data 408 including training meter image(s) 418 and their associated training label(s) 420. In an example, the meter image recognition model 334, when trained, is capable of extracting relevant information from images of utility meters, which may be used to verify the authenticity of utility bills. The training process for this model may involve computer vision techniques, potentially utilizing convolutional neural networks (CNNs) or other deep learning architectures suitable for image recognition tasks. The model may learn to identify and interpret various types of meter displays, including digital and analog formats, across different utility types.

Once trained, these models may be utilized within the utility bill resolution system 108 for detecting anomalies in utility bills and verifying meter readings. The anomaly detection model 332 may be employed to automatically flag suspicious bills for further review, potentially identifying issues such as meter malfunctions, billing errors, or unexpected changes in consumption patterns. On the other hand, the meter image recognition model 334 may be used to cross-verify billed amounts with actual meter readings, providing an additional layer of accuracy and fraud detection.

The training process for both models may involve iterative refinement, including techniques such as cross-validation, hyperparameter tuning, and regularization to ensure optimal performance and generalization. The system 402 may also incorporate mechanisms for continuous learning, allowing the models to adapt to new patterns and scenarios over time as more data becomes available.

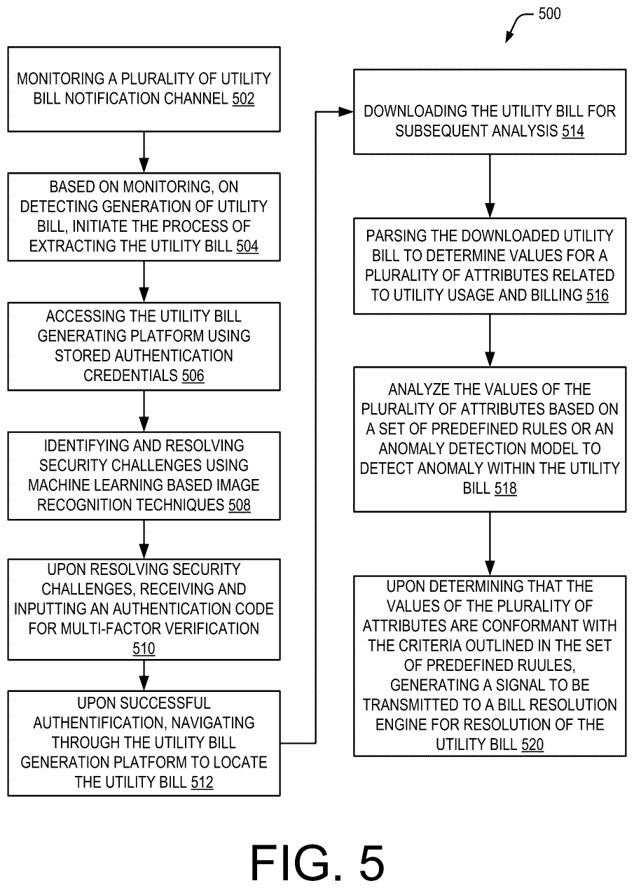

FIG. 5 illustrates example method 500 for managing and resolving utility bill. The order in which the above-mentioned method is described is not intended to be construed as a limitation, and some of the described method blocks may be combined in a different order to implement the method, or alternative method. Based on the present approaches as described in the context of the example method 500, the utility bill is extracted and analyzed to determine presence of any anomaly within the utility bill.

Further, the above-mentioned method 500 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a utility consumption optimization system, such as resolution system 108. In an implementation, the method may be performed under an “as a service” delivery model, where the resolution system 108, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned method.

At block 502, a plurality of utility bill notification channels are monitored. For example, the monitoring module 314 of the extraction engine 206 may continuously monitors a plurality of utility bill notification channels, such as channels 208, to detect generation of the utility bill(s) 338. Examples of channels 208 include, but are not limited to, SMS notifications sent directly from utility companies, email notifications to registered customer accounts, mobile application push notifications for customers who have installed the utility company's app, utility company website bill generation alerts that may be scraped or accessed via API, WhatsApp messaging Application notification, direct API notifications from utility company billing systems, and smart meter data feeds that indicate the completion of a billing cycle.

At block 504, based on monitoring, on detecting generation of the utility bill, a process for extracting the utility bill is initiated. For example, when the monitoring module 314 detects the generation of a new utility bill, such as utility bill 210, by a utility provider 202 corresponding to the monitored utility consumption site, the extraction engine 206 initiates the bill extraction process. The process of extraction of utility bill may vary depending on the notification channel through which the bill availability was detected. For example, for SMS or email notifications, the extraction engine 206 may parse the message content to identify bill download links or login instructions. For website alerts or API notifications, the extraction engine 206 may directly initiate a connection to the utility provider's system.

At block 506, the utility bill generating platform is accessed using stored authentication credentials. For example, the login module 316 implements the authentication process required to access the utility bill generation platform. The login module 316 may maintain a secure database of stored authentication credentials for each utility provider and consumption site. These credentials may include usernames, passwords, account numbers, and any additional authentication factors that may be required by the utility provider. In an example, the login module 316 may also implement encryption and secure storage practices to protect credentials.

At block 508, security challenges are identified and resolved. For example, once the login module 316 initiates the authentication process, the security module 318 comes into play to handle any additional security challenges presented by the utility bill generation platform. One of the common security measures encountered is CAPTCHA verification, designed to prevent automated access. The security module 318 employs advanced machine learning-based image recognition techniques to identify and solve these challenges. For image-based CAPTCHAs, the security module 318 may use convolutional neural networks trained on large datasets of CAPTCHA images to recognize and select the required elements, such as street signs, vehicles, or storefronts. For text-based CAPTCHAs, the module may utilize optical character recognition (OCR) in combination with text distortion correction algorithms to decipher the presented characters.

At block 510, upon resolving security challenges, an authentication code is received and inputted for multi-factor authentication. For example, after successfully navigating any initial security challenges, many utility providers implement multi-factor authentication as an additional security layer. To cater this, the extraction engine 206 includes the authentication module 320. For example, on resolving the security challenges, the resolution system 108 may receive authentication codes through various channels, such as SMS, email, or dedicated authentication applications. The authentication module 320 may retrieve these codes from the designated channel and input them into the utility provider's system. In cases where manual input is required, the authentication module 320 queue the authentication request for human intervention, ensuring that the automated process may continue with minimal delay.

At block 512, upon successful authentication, the utility bill generation platform is navigated to locate the utility bill. For example, upon successful completion of multi-factor authentication, the crawler module 322 takes over to navigate the user interface of the utility bill generation platform. In an example, the crawler module 322 may employ web scraping techniques to traverse the website's structure, following links and interacting with elements to locate the specific page or section where the utility bill is available.

At block 514, the utility bill is downloaded for subsequent analysis. For example, once the crawler module 322 has located the utility bill(s) 338, the scraper module 324 is activated to download the bill. The scraper module 324 may handle various file formats, including PDF, HTML, CSV, or proprietary formats used by specific utility providers. The scraper module 324 may employ different techniques depending on the file format, such as direct download for PDF files, HTML parsing for web-based bills, or API calls for providers that offer programmatic access to billing data. The scraper module 324 may also handle any compression or encryption applied to the bill files, ensuring that the downloaded content is in a format ready for further processing.

At block 516, the downloaded utility bill is parsed to determine values for a plurality of attributes related to utility usage and billing. For example, once the utility bill 210 is successfully downloaded, it is stored as utility bill(s) 338 in data 336 in the resolution system 108. Thereafter, the utility bill(s) 338 is transferred to the parsing engine 212 for further processing. For example, the parsing engine 212 begins the process of extracting relevant information from the utility bill(s) 338. In an example, the context extraction module 326 of the parsing engine 212 may first determine the structure and format of the bill, which may vary significantly between utility providers. It may identify key sections of the bill, such as the summary, detailed usage breakdown, and payment information.

Thereafter, the OCR module 328 is then employed to convert any image-based or scanned bill components into machine-readable text. The OCR module 328 may use advanced OCR algorithms capable of handling various fonts, layouts, and potential image distortions. It may also incorporate pre-processing steps such as image de-skewing, noise reduction, and contrast enhancement to improve recognition accuracy.

Once the bill content is in text format, the NLP module 330 processes this text to identify and categorize information corresponding to the plurality of attributes required for analysis and store the identified values as bill attribute(s) 340 in the data 336 of the resolution system 108. In an example, the NLP module 330 may employ techniques such as named entity recognition to identify specific types of information (e.g., dates, monetary amounts, meter numbers), part-of-speech tagging to understand the structure of sentences and phrases, and semantic analysis to interpret the meaning and context of extracted information.

At block 518, the values of the plurality of attributes are analyzed based on a set of predefined rules or an anomaly detection model to detect anomaly within the utility bill. For example, once the utility bill(s) 338 is parsed and bill attribute(s) 340 are determined, the analysis engine 112 begins its analytical process to detect anomalies within the utility bill(s) 338. In an example, the analysis engine 112 may perform this analytical assessment based on a machine learning model, such as anomaly detection model 332, or based on a set of predefined set of rules.

In an example, in case of analysis based on set of predefined rules, the analysis engine 112 analyze the determined bill attribute(s) 340 based on a set of predefined rules In an example, the analysis engine 112 may apply logical conditions to determine whether the values of the bill attribute(s) 340 are conformant with the criteria outlined in the set of predefined rules.

In an example, the predefined set of rules encompass a wide range of checks to ensure comprehensive bill verification. For example, the predefined set of rules include:
Consumption thresholds that are established to flag bills where usage exceeds or falls below expected ranges for different time periods, taking into account factors like seasonality and historical usage patterns.
Expected billing ranges that are used to identify bills where the total amount falls outside anticipated ranges based on historical data and known rate changes. In this case, the analysis engine 112 checks for logical progression of meter readings between consecutive billing cycles, flagging cases of meter rollback or implausible jumps in readings.
Usage patterns that are analyzed against typical profiles for the customer's category (e.g., residential, commercial, industrial), with significant deviations being flagged for review.
Seasonal adjustments are accounted for, ensuring that bills align with expected seasonal variations in utility consumption. The system identifies abrupt changes in consumption or billing amounts that exceed predefined thresholds for month-to-month or year-over-year variations. For sites with multiple utility services, the system checks for expected ratios between different services (e.g., electricity vs. gas consumption) and flags inconsistencies.
Tariff compliance is verified to ensure that applied rates and charges comply with the latest approved tariff structures and any special rate plans applicable to the customer. The system crosschecks the consistency between reported consumption, applied rates, and calculated charges to ensure charge calculation accuracy. Additionally, regulatory compliance is ensured by verifying that the bill structure and charges align with current regulatory guidelines for utility billing in the relevant jurisdiction.

In another example, in case of assessment based on the anomaly detection model 332, the analysis engine 112 may analyze the values comprised within the bill attribute(s) 340 based on the anomaly detection model 332 to detect anomalies indicating progression of values of at least one of the plurality of attributes outside normal ranges corresponding to that attribute. In an example, the anomaly detection model 332 may be a machine learning model, trained potentially based on techniques such as isolation forests, autoencoders, or ensemble methods combining multiple anomaly detection approaches. In one example, the anomaly detection model 332 is trained based on a plurality of training utility bills, with each training utility bill comprising a training value corresponding to the plurality of attributes and a corresponding training indicator indicating normal and anomalous status of the training utility bill.

At block 520, upon determining that the values of the plurality of attributes are conformant with the criteria outlined within the set of predefined rules, a signal is generated to be transmitted to a bill resolution engine for resolution of the utility bill. For example, for utility bill(s) 338 that pass all checks without triggering anomalies, the resolution engine 214 initiates the bill resolution process via the payment gateway 216, which may involve verifying funds, initiating automated payments, updating accounting systems, generating payment confirmations, and updating bill status.

In another example, the resolution system 108 may be configured to handle prepaid billing processes for smart meters. In this scenario, an online wallet may be maintained for each utility consumption site. The resolution engine 214 may include various modules (not shown in FIG. 2) that continuously track these online wallets, with each consumption site potentially having a distinct wallet. The login process for accessing these wallets may be similar to that used for postpaid billing, followed by crawling and scraping operations to retrieve wallet-related data such as current balance.

The resolution engine 214 may generate alerts when a wallet balance falls below a predetermined threshold. This threshold may be a fixed amount or an intelligent, consumption-based level. Upon detecting a low balance, the system may automatically initiate a wallet recharge process. If a wallet balance reaches zero, the utility services at the corresponding consumption site may be automatically suspended until payment is added to the wallet.

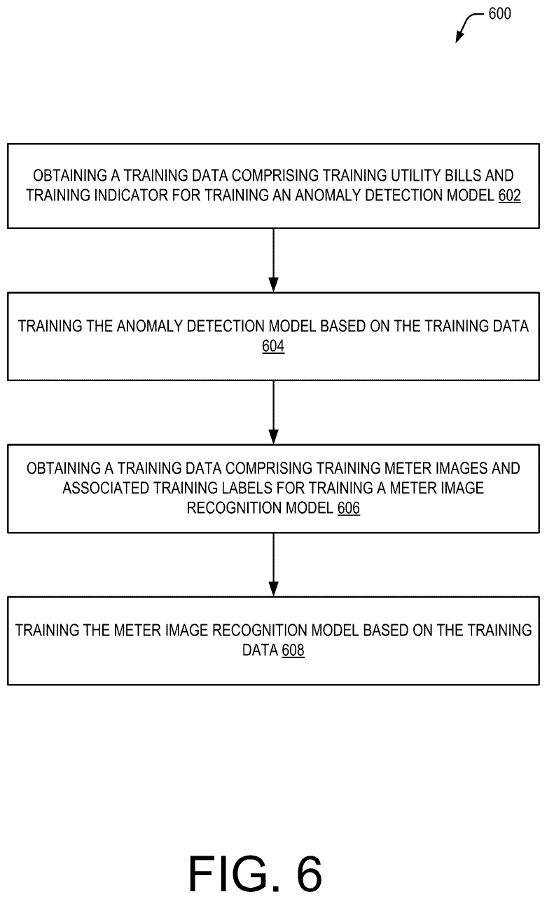

FIG. 6 illustrates an example method 600 for training an anomaly detection model and a meter image recognition model, in accordance with examples of the present subject matter. The order in which the above-mentioned method is described is not intended to be construed as a limitation, and some of the method blocks described may be combined in a different order to implement the method, or alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a training system, such as system 402. In an implementation, the method may be performed under an “as a service” delivery model, where the system 402, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned method.

In an example, the method 600 may be implemented by the system 402 for training one or more machine learning model/artificial Intelligence model based on a training data, such as training data 408. At block 602, a training data comprising training utility bills and training indicator is obtained. For example, the training engine 412 obtains training data 408 from the repository 404 including training utility bill(s) 414 and their corresponding training indicator(s) 416. In an example, each of the training utility bill comprised within the training utility bill(s) 414 includes a training value corresponding to the plurality of attributes which are related to utility usage and billing. Examples of such attribute include but are not limited, utility consumption data, billing amount, tariff levied details, due date, meter identification number, customer information, billing period, rate schedules, special charges, historical consumption data, payment history, and utility provider information. Further, the training indicator(s) 416 include status details of each of the training utility bill(s) 414 indicating either normal or anomalous status of the utility bill.

At block 604, an anomaly detection model is trained based on the training data. For example, the training engine 412 trains the anomaly detection model 332 based on the training data. In an example, the anomaly detection model 332, when trained, is capable of detecting anomalies within utility bills by analyzing various attributes and identifying when their values progress outside normal ranges. The training process may involve techniques such as supervised learning, where the anomaly detection model 332 to associate values of specific bill attributes with normal or anomalous labels indicators, or unsupervised learning methods like clustering or autoencoders to identify outliers in the data.

At block 606, a training data comprising training meter images and associated training labels is obtained. For example, the training engine 412 obtains training data 408 from the repository 404 including training meter image(s) 418 and their associated training label(s) 420. In an example, the training meter image(s) 418 include images of utility meter captured from various angles, with varied illumination, with varied quality of cameras, etc. Further, the training label(s) 420 include details corresponding to each training meter image(s) 418 indicating location of presence of various attributes of the utility bill.

At block 608, a meter image recognition model is trained based on the training data. For example, the training engine 412 trains the meter image recognition model 334 based on the training data 408 including training meter image(s) 418 and their associated training label(s) 420. In an example, the meter image recognition model 334, when trained, is capable of extracting relevant information from images of utility meters, which may be used to verify the authenticity of utility bills. The training process for this model may involve computer vision techniques, potentially utilizing convolutional neural networks (CNNs) or other deep learning architectures suitable for image recognition tasks. The model may learn to identify and interpret various types of meter displays, including digital and analog formats, across different utility types.

Once trained, these models may be utilized within the utility bill resolution system 108 for detecting anomalies in utility bills and verifying meter readings. The anomaly detection model 332 may be employed to automatically flag suspicious bills for further review, potentially identifying issues such as meter malfunctions, billing errors, or unexpected changes in consumption patterns. On the other hand, the meter image recognition model 334 may be used to cross-verify billed amounts with actual meter readings, providing an additional layer of accuracy and fraud detection.

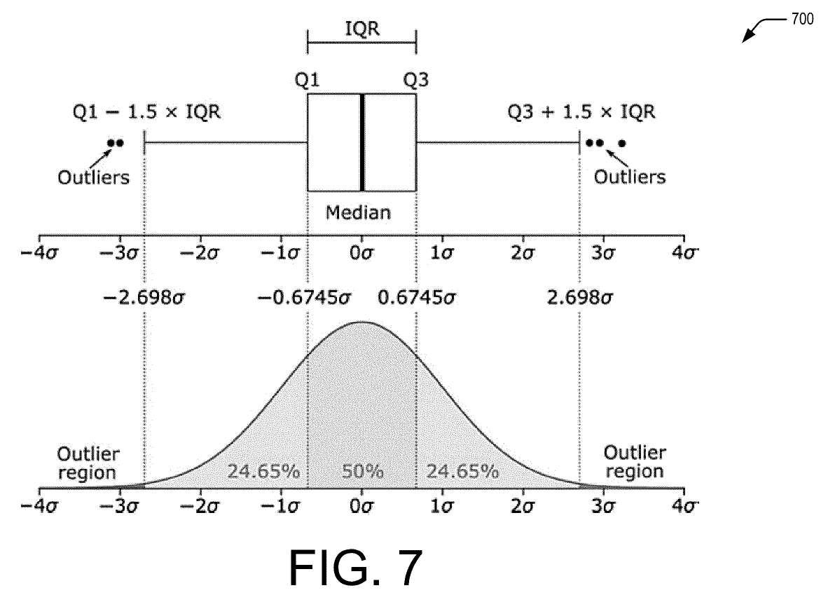

FIG. 7 illustrates a statistical distribution diagram 700 showing the interquartile range (IQR) method for detecting outliers, including a box plot and normal distribution curve, as an example of the present subject matter. As described above, the resolution system 108 may identify anomalies based on the set of predefined rules. In one example, the resolution system 108 do so by identifying outliers in the utility billing data. FIG. 7 illustrates the statistical method used for outlier detection, specifically the IQR technique.

In the context of utility bill analysis, the resolution system 108 applies this IQR technique to various attributes of the utility bill, such as utility consumption, billing amount, or specific charges. The process begins with the distribution of values for a particular attribute (e.g., monthly utility consumption) across multiple billing periods, represented on the horizontal axis of FIG. 7, while the vertical axis shows the frequency or number of occurrences for each value range. The system divides the data into four equal parts or quartiles, represented by the box in the box plot, where the lower edge of the box represents the first quartile (Q1), the line inside the box represents the median or second quartile (Q2), and the upper edge represents the third quartile (Q3).

The Interquartile Range (IQR) is calculated as the difference between Q3 and Q1, representing the middle 50% of the data and shown by the height of the box in FIG. 7. The resolution system 108 then defines outlier thresholds using the IQR, typically considering values falling below Q1−1.5×IQR or above Q3+1.5×IQR as potential outliers, represented by the whiskers extending from the box. Any data points falling beyond these whiskers are flagged as potential outliers, which in the context of utility bills may represent unusually high or low consumption or billing amounts that warrant further investigation. The curve overlaid on the box plot in FIG. 7 represents a normal distribution, helping visualize how the actual data distribution compares to what would be expected in a perfectly normal distribution. The percentages shown on the right side of FIG. 7 (50%, 24.65%, etc.) indicate the expected proportion of data falling within certain ranges of a normal distribution, helping quantify how unusual an outlier is in the utility bill analysis context.

In practice, the resolution system 108 applies this technique to multiple attributes of utility bills over time. For example, it might analyze monthly kWh usage, flagging bills where consumption falls outside the calculated thresholds to identify months with unexpectedly high or low energy use. By applying the IQR technique to total bill amounts, the resolution system 108 may identify bills that are unusually expensive or cheap relative to historical data. The resolution system 108 might also analyze individual components of the bill, such as demand charges or taxes, to detect anomalies in specific billing elements. This comprehensive approach allows the resolution system 108 to identify a wide range of potential issues in utility bills, from unexpected consumption patterns to billing errors or changes in rate structures, providing a robust method for anomaly detection in the utility bill management process.

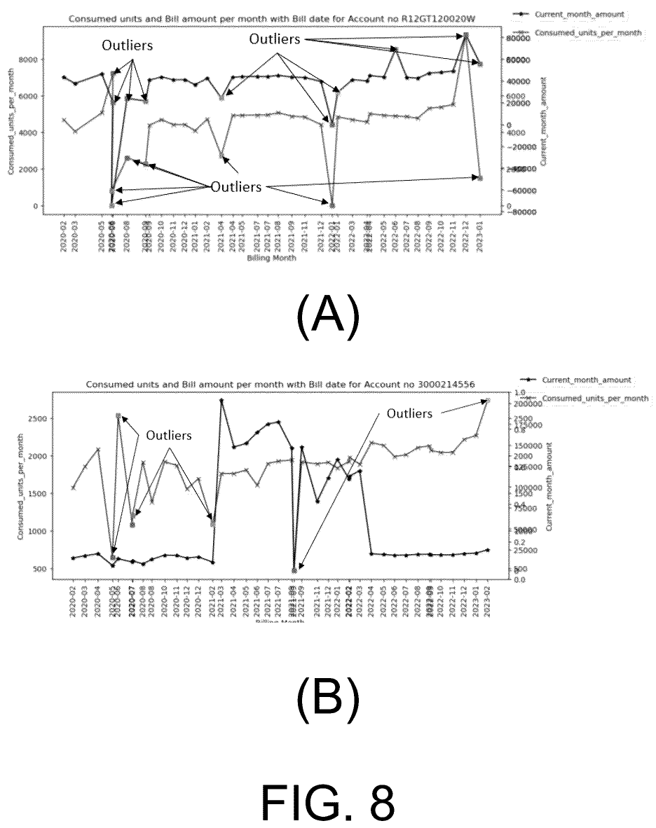

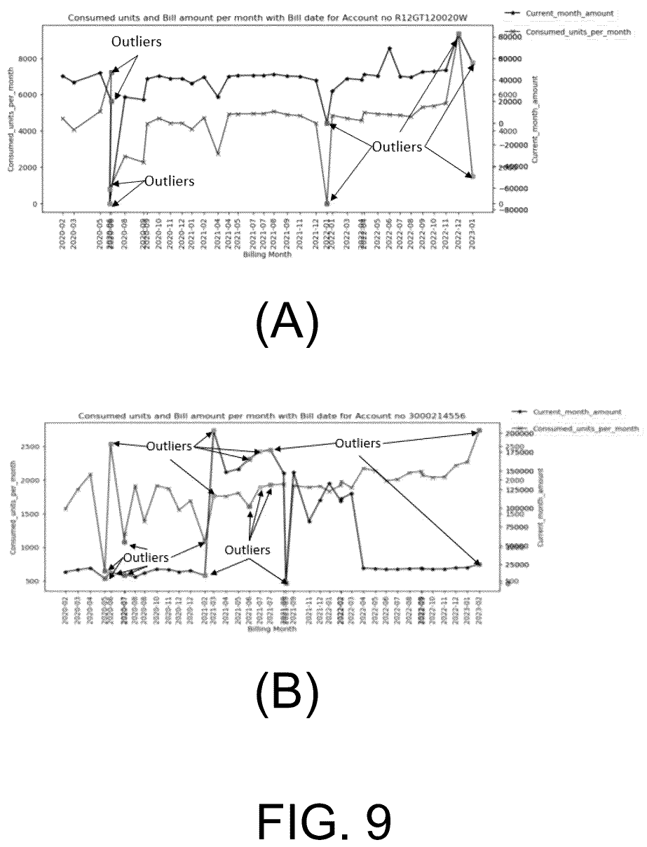

Referring to FIGS. 8A and 8B, example bills over a period between February 2020 to January 2023 is shown, in accordance with some embodiments. In some embodiments, the graphs shown in FIGS. 8 and 9 may be shown on a mobile app or web application that includes a user interface. As indicated in FIGS. 8A and 8B, the user may be shown that certain months may be considered outliers based on the IQR technique.

In some embodiments, an outlier detection technique may include the use of Mahalanobis distance. In some embodiments, the Mahalanobis distance technique may include a multivariate analysis which calculates the distance between a data point and the data set's distribution. Referring to FIGS. 9A and 9B, the same data sets of the graphs of the FIGS. 8A and 8B are shown, respectively. However, the numbers and identification of outliers that are detected using the IQR technique are different than the Mahalanobis distance technique.

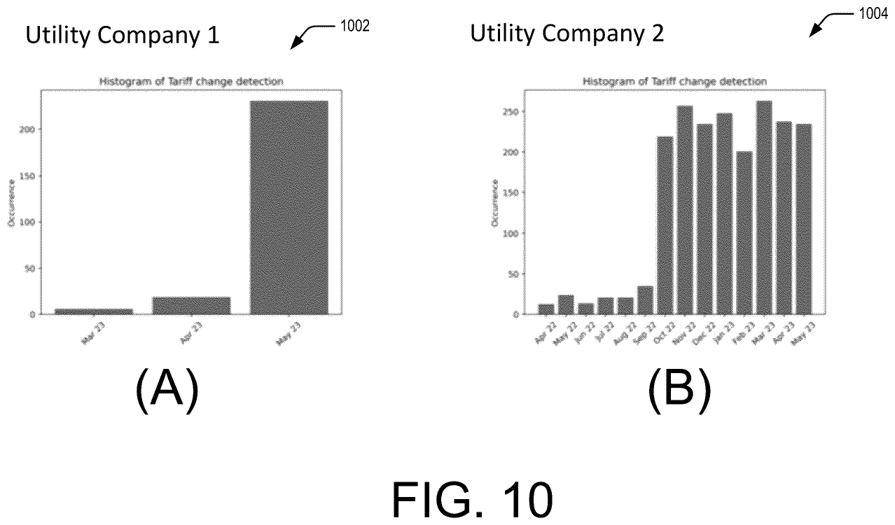

FIG. 10A-B illustrates histograms showing tariff change detection patterns for two different utility companies, i.e., 1002 and 1004, highlighting periods of significant rate changes, as per an example of the present subject matter. FIGS. 10A and 10B each illustrates a histogram of tariff change detection using example data sets, in accordance with some embodiments. The “occurrence” indicates how many sites with tariff changes were detected for the utility company 1 in FIG. 10A and utility company 2 in FIG. 10B. Referring to FIG. 10A, a tariff change is easily detected based on the drastic increase between April 2023 and May 2023. Referring to FIG. 10B, a tariff change is again easily detected in October 2022 due to the drastic increase.

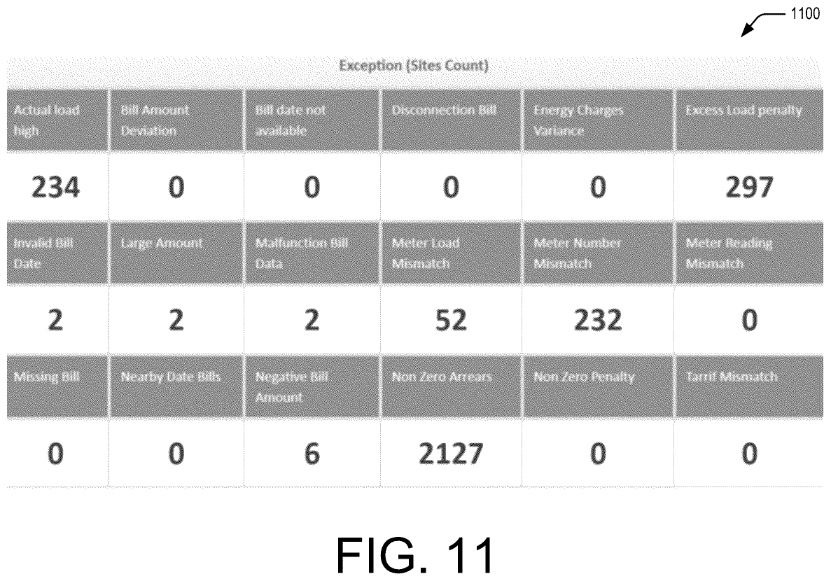

FIG. 11 illustrates a user interface 1100 showing exception count for various utility billing parameters, including meter mismatch, bill deviations, and load-related anomalies, as per an example of the present subject matter. This user interface is crucial for monitoring and categorizing different types of billing anomalies detected by the resolution system 108. It displays counts for various exceptions such as actual load high count (234), bill amount deviation count (0), excess load penalty count (297), invalid bill date count (2), meter load mismatch count (52), meter number mismatch count (232), negative bill amount count (6), and non-zero arrears count (2127). This comprehensive view of billing exceptions allows the resolution system 108 to prioritize issues, focus on the most frequent or critical anomalies, and track the overall health of the billing process.

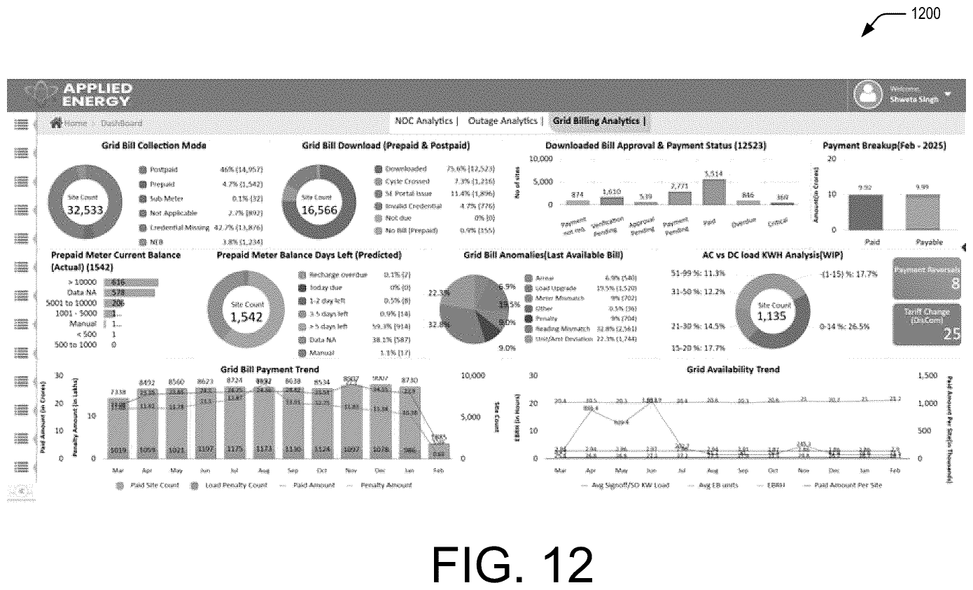

FIG. 12 depicts a dashboard interface 1200 for managing utility billing analytics and metrics, as per an example of the present subject matter. The dashboard interface is a key output which is provided by the resolution system 108, providing a user-friendly way to visualize and interact with billing data. The dashboard interface includes various visualization components such as pie charts for grid bill collection modes and prepaid meter balances, bar graphs for payment trends, and line graphs tracking grid availability. The dashboard also displays numerical metrics and breakdowns of different payment categories. This comprehensive view enables users to monitor key billing and usage parameters across multiple utility accounts and sites, facilitating informed decision-making and quick identification of areas requiring attention.

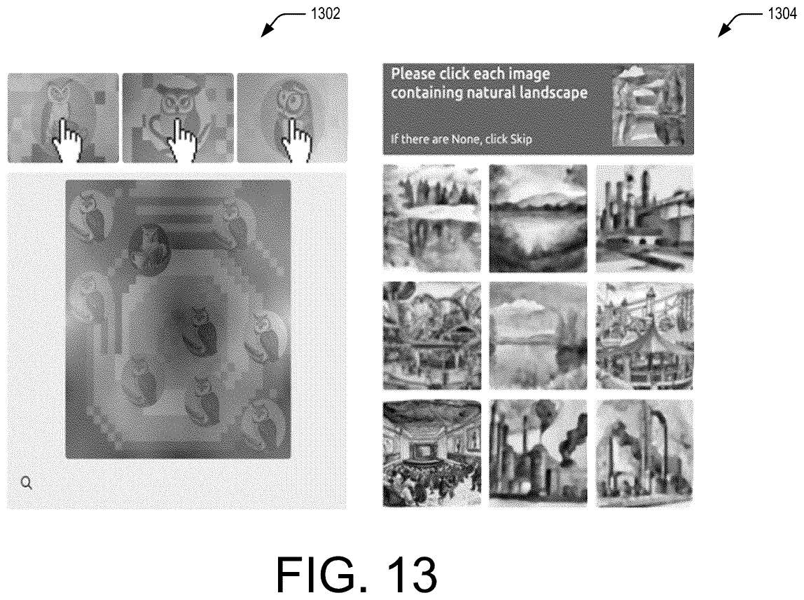

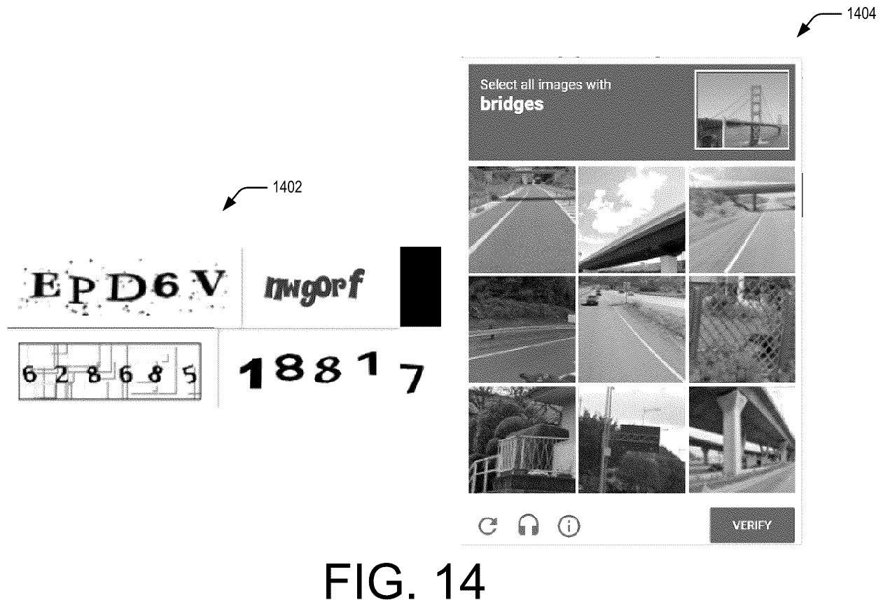

FIGS. 13-14 depicts various CAPTCHA verification interfaces used for human verification in web systems. These interfaces, labeled 1302, 1304, 1402, and 1404, represent security measures that the utility bill extraction engine must navigate when accessing utility provider websites to retrieve bills. The system's ability to handle these verification challenges automatically is crucial for maintaining the automated nature of the bill retrieval process. The utility bill resolution system may employ advanced image recognition and processing techniques to overcome these security measures without human intervention.

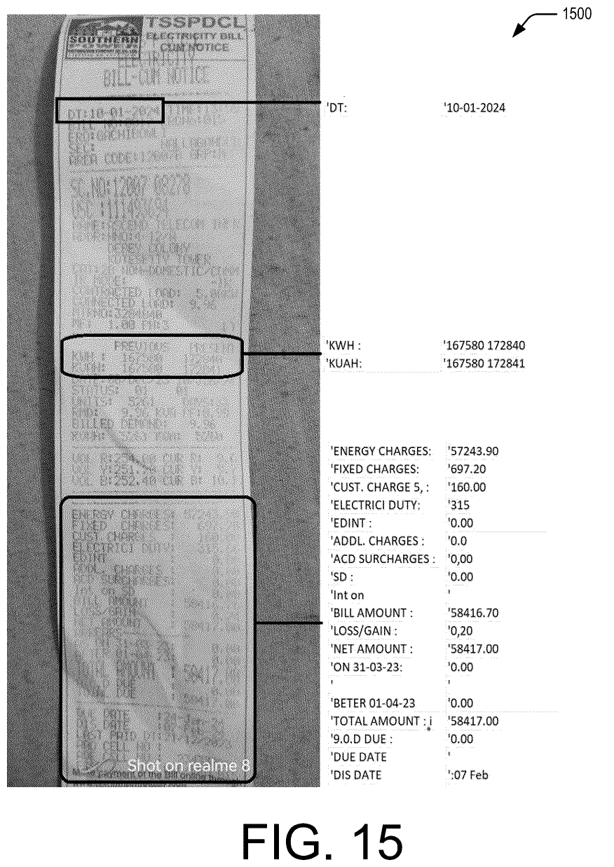

It may be noted that, it is possible that instead of obtaining the utility bill(s) 338 or utility bill 210 automatically, a user operating on the resolution system 108 may provide a physical copy of the utility bill for analysis. FIG. 15 illustrates an orthogonal view 1500 of a utility bill, detailing various charges and amounts. The parsing engine 212 using the OCR technique may parse the utility bill to identify and categorize text from the utility bill to the plurality of attributes. As depicted in FIG. 15, the bill includes energy charges (57243.90), fixed charges (907.20), electricity duty (716.00), total charges (58867.10), a surcharge (5.20), and the net amount (58617.90). The parsing engine 212 of the resolution system 108 must accurately extract and categorize these different components to enable proper analysis and anomaly detection.

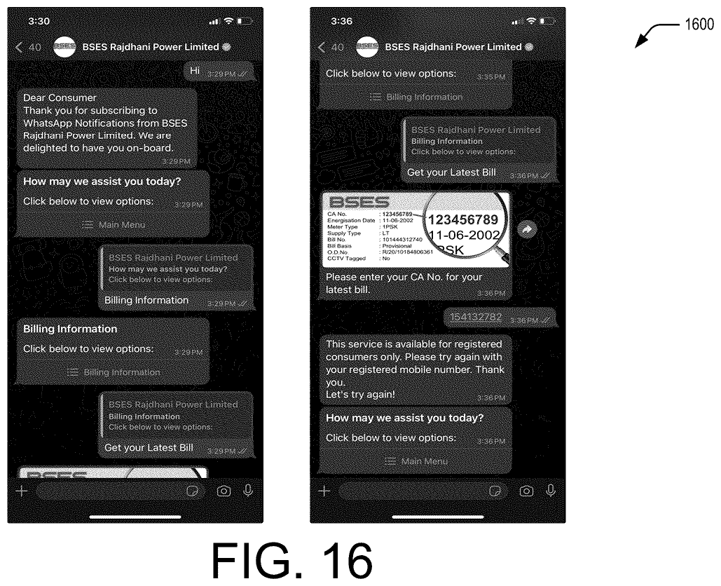

FIG. 16 illustrates example screenshots 1600 of a conversation between the utility provider 202 chatbot and a customer related to bill payments, as per an example of the present subject matter. To extract the utility bill, the monitoring module 314 may read messages sent by a via a messaging service (e.g., WhatsApp, Messenger, etc.) by the utility provider to the customer automatically. An example of such message is notification of availability of a new bill. In continuation of such detection, other modules of the analysis engine 112 may parse these messages, automatically download the bill, and send the bill for further processing to the parser engine 212.

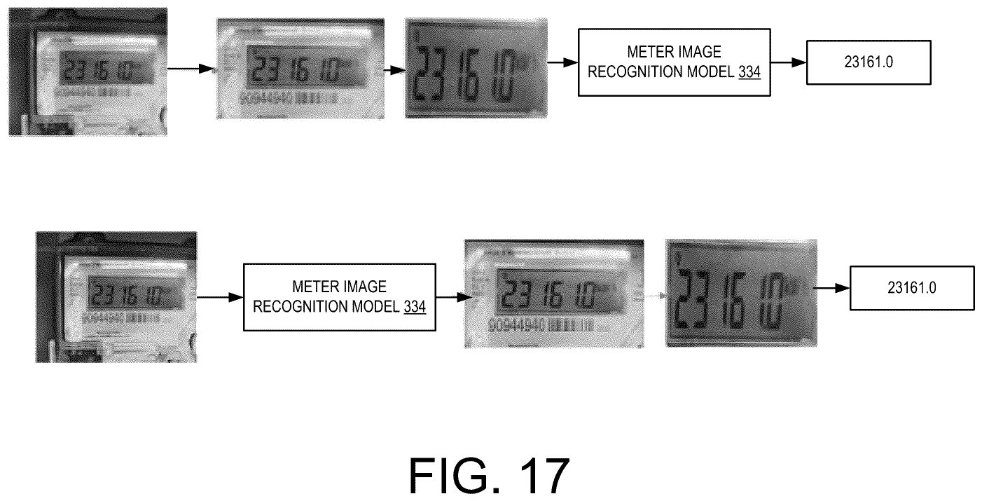

FIG. 17 illustrates the process of attribute value recognition using a meter image recognition model based on meter images. The figure demonstrates how the model analyzes visual data from utility meter photographs to extract relevant information. The meter image recognition model, trained on a diverse dataset of meter images, employs advanced computer vision techniques to identify and interpret various meter display types, including digital and analog formats. The model processes the input image through multiple layers, detecting key features such as digit shapes, dial positions, and display layouts. It then translates these visual elements into numerical values corresponding to specific attributes like utility consumption or meter readings. The figure may show sample input images alongside the model's output, highlighting the accuracy and efficiency of the automated reading process. This visual representation underscores the system's capability to automate meter reading tasks, reducing human error and streamlining the utility billing process.

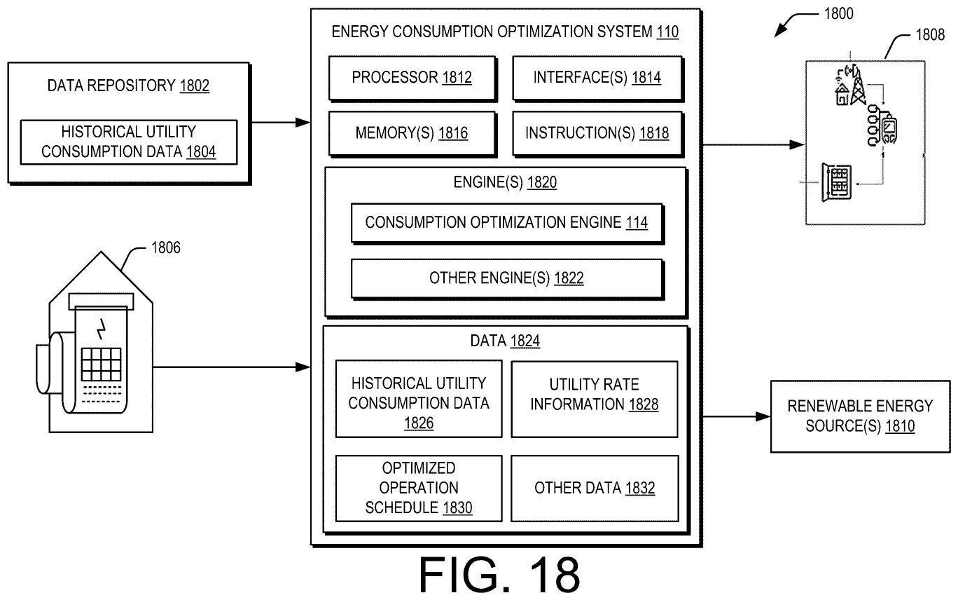

FIG. 18 illustrates a communication environment 1800 including a detailed block diagram of an utility consumption optimization system for optimizing operation of a utility consumption site, as per an example of the present subject matter. As depicted in FIG. 18, the communication environment 1800 includes the utility consumption optimization system 110 (referred to as optimization system 110) which is communicably connected with a data repository 1802. In an example, the data repository 1802 includes historical utility consumption data 1804 corresponding to various utility consumption site.

The optimization system 110 is also connected over a network (not shown in FIG. 18) with a utility provider 1806. The utility provider 1806 is responsible for providing utility services to a utility consumption site 1808. In an example, the utility consumption site 1808 is the site whose operations are being analyzed to optimize the performance of the utility consumption site. Further, the optimization system 110 may be connected to a plurality of renewable energy source(s) 1810 for enabling/disabling these source(s) when required.

Similar to the resolution system 108, the optimization system 110 may also include components such as a processor 1812, interface(s) 1814, and memory(s) 1816. The processor 1812 may be implemented as microprocessors, microcomputers, microcontrollers, digital signal processors, central processing units, state machines, logic circuitries, and/or other devices that manipulate signals based on operational instructions. Among other capabilities, the processor 1812 may be configured to obtain historical utility consumption data and utility rate information corresponding to the utility consumption site 1808 whose operations and/or equipment are being analyzed to optimize the performance. The processor 302 may then analyze the historical utility consumption data with the utility rate information to identify energy intensive equipment and/or processes to be rescheduled or powered by renewable sources of energy.

The interface(s) 1814 may allow the connection or coupling of the optimization system 110 with one or more data repositories through a wired network, a wireless network, or a combination of a wired and wireless network. The interface(s) 1814 may also enable intercommunication between different logical as well as hardware components of the optimization system 110.

The memory(s) 1816 may be a computer-readable medium, examples of which include volatile memory (e.g., RAM), and/or non-volatile memory (e.g., Erasable Programmable read-only memory, i.e., EPROM, flash memory, etc.). The memory(s) 1816 may be an external memory, or internal memory, such as a flash drive, a compact disk drive, an external hard disk drive, or the like. The memory(s) 1816 may further include data which either may be utilized or generated during the operation of the optimization system 110.

Similar to the resolution system 108, the optimization system 110 may further include instruction(s) 1818 and engine(s) 1820. In an example, the instruction(s) 1818 are fetched from the memory(s) 1816 and executed by the processor 1812 included within the optimization system 110. The engine(s) 1820 may include the consumption optimization engine 114 and other engine(s) 1822. The other engine(s) 1822 may further implement functionalities that supplement functions performed by the optimization system 110 or any of the engine(s) 1820.

The consumption optimization engine 114 may be implemented as a combination of hardware and programming, for example, programmable instructions to implement a variety of functionalities. In examples described herein, such combinations of hardware and programming may be implemented in several different ways. For example, the programming for the consumption optimization engine 114 may be executable instructions, such as instruction(s) 1818. Such instruction(s) 1818 may be stored on a non-transitory machine-readable storage medium which may be coupled either directly with the optimization system 110 or indirectly (for example, through networked means).

In an example, the consumption optimization engine 114 may include a processing resource, for example, either a single processor or a combination of multiple processors, to execute such instructions. In the present examples, the non-transitory machine-readable storage medium may store instructions, such as instruction(s) 1818, that when executed by the processing resource, implement the consumption optimization engine 114. In other examples, the consumption optimization engine 114 may be implemented as electronic circuitry.

The optimization system 110 may further a data 1824 including data that is utilized or generated by the optimization system 110, while performing a variety of functions. In an example, the data 1824 further includes historical utility consumption data 1826, utility rate information 1828, optimized operation schedule 1830, and other data 1832. Further, the other data 1832, amongst other things, may serve as a repository for storing data that is processed, or received, or generated as a result of the execution of the instructions by the processor 1812.

In operation, the optimization system 110 functions to analyze historical utility consumption data 1804 and optimize energy usage patterns for the utility consumption site 1808. In an example, the optimization system 110 initially obtains historical utility consumption data 1804 corresponding to the utility consumption site 1808 from the data repository 1802, which stores information collected over time from the utility provider 1806. In an example, upon obtaining, the data is stored is as historical utility consumption data 1826 (referred to as consumption data 1826) in the data 1824 of the optimization system 110. This consumption data 1826 may comprise detailed records of energy usage patterns and consumption trends, potentially spanning several years. The consumption data 1826 may include utility consumption patterns showing hourly, daily, weekly, and monthly usage fluctuations, identification of peak demand periods, breakdown of utility consumption by specific equipment or processes, temporal variations such as seasonal changes or differences between weekday and weekend usage, and non-temporal variations like changes in consumption due to equipment upgrades or operational modifications.

Simultaneously, the optimization system 110 obtains utility rate information 1828 corresponding to the utility consumption site from the utility provider 1806. Such information is for understanding the cost implications of energy usage patterns, especially in the context of Time of Day (ToD) or Time of Use (ToU) billing structures. The utility rate information 1828 may include pricing structures and rate schedules that vary based on time of day, season, or consumption levels. It may encompass ToD or ToU rate schedules indicating utility prices for different periods within a 24-hour cycle (such as peak, mid-peak, and off-peak hours), demand charge structures based on peak utility consumption, seasonal variations in rates or structures, and any special tariffs or incentives offered by the utility provider.

The optimization engine 114, implemented within the optimization system 110, then analyzes the consumption data 1826 with respect to the utility rate information 1828. In an example, such analysis aims to identify energy-intensive equipment and/or processes operating during high-rate periods, particularly focusing on ToD or ToU pricing impacts. The analysis engine 112 may employ various analytical techniques, including statistical analysis, machine learning algorithms, and pattern recognition methods. It may identify correlations between operational schedules and high energy costs during peak ToD or ToU periods, pinpoint equipment or processes that consistently operate during peak rate hours, and quantify the financial impact of current usage patterns.

Based on this comprehensive analysis, the optimization system 110 generates the optimized operation schedule 1830 for the utility consumption site 1808. This schedule provides detailed recommendations to the utility consumption site 1808 to re-allocate the operation of utility-intensive equipment and processes to lower-rate periods where operationally feasible, taking full advantage of ToD or ToU pricing structures. Further, the optimized schedule may suggest shifting certain production processes to off-peak hours, e.g., adjusting HVAC system operations to pre-cool or pre-heat spaces during lower-rate periods, or coordinating the charging of electric vehicles or battery systems to take advantage of the lowest available ToD or ToU rates.

The optimization system 110 may also incorporate peak shaving strategies into the optimized operation schedule. In an example, the peak shaving involves reducing the amount of energy purchased from the utility during peak demand periods, which often correspond to the highest ToD or ToU rates. This may be achieved by temporarily reducing non-essential loads, utilizing on-site energy storage systems, such as secondary storage source(s) 1810, such as batteries or other energy storage devices, which are charged using renewable sources of energy, such as wind, solar, etc. To do so, the optimization engine 114 may analyze historical peak demand data and current energy usage to predict when peak demand is likely to occur and automatically implement peak shaving measures to avoid high demand charges. In an example, the optimization engine 114 generates control signals to switch the energy supplied to the equipment and/or processes from utility provider to the energy provided by the secondary storage source(s) 1810, such as batteries.

Returning to the present example, to implement the optimized operational schedule and peak shaving strategies, the optimization system 110 may generate control signals to be transmitted to a plurality of Internet of Things (IoT) equipment installed at the utility consumption site 1808. These signals could automatically adjust equipment settings, start or stop processes, or modify operational parameters to align with the optimized schedule and ToD or ToU rate periods. For example, the optimization system 110 might send signals to smart thermostats to adjust temperature setpoints during peak rate hours, to energy management systems to cycle non-essential equipment for peak shaving, or to production control systems to reschedule energy-intensive processes to off-peak periods.

Further, as part of the peak shaving strategy, the optimization system 110 may also prioritize the usage of secondary energy source(s) 1810 when available to reduce carbon footprint and reliance on non-renewable sources, especially during high ToD or ToU rate periods. In an example, the optimization system 110 may generate signals for the battery storage systems to charge during periods of excess renewable generation or low ToD/ToU rates, and discharge during high-rate grid periods or for peak shaving purposes.

Throughout its operation, the optimization system 110 continuously updates and refines its models based on new data. It may periodically re-analyze consumption patterns, incorporate updates to ToD or ToU rate structures, and adjust its optimization and peak shaving strategies based on feedback from actual implementation results. This ongoing process ensures that the optimization system 110 maintains optimal energy efficiency and cost-effectiveness over time, adapting to changes in operational needs, utility pricing structures, and available technologies while maximizing the benefits of ToD/ToU pricing and minimizing peak demand charges.

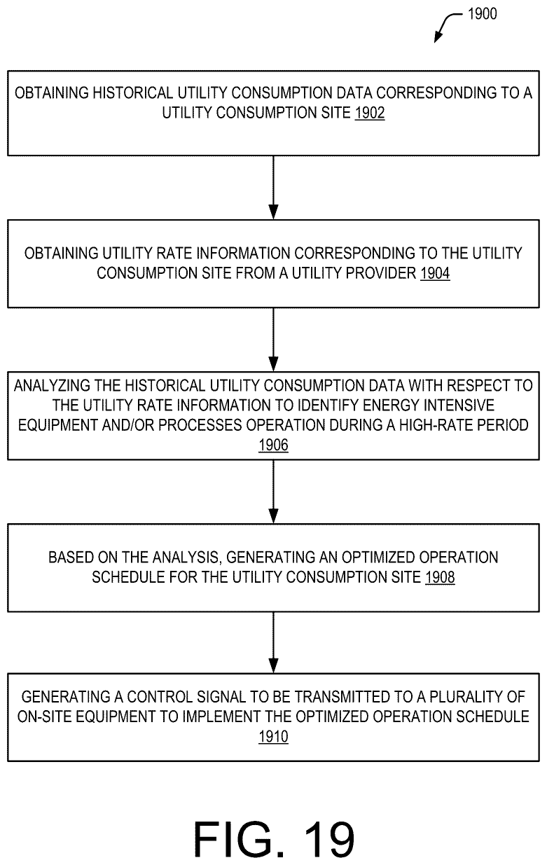

FIG. 19 illustrates example method 1900 for optimizing operation of a utility consumption site. Similar to FIG. 5, the order in which the above-mentioned method is described is not intended to be construed as a limitation, and some of the described method blocks may be combined in a different order to implement the method, or alternative method. Based on the present approaches as described in the context of the example method 1900, the historical utility consumption data of the utility consumption site is analyzed based on the utility rate information to generate the optimized operational schedule.

Further, the above-mentioned method 1900 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a utility consumption optimization system, such as optimization system 110. In an implementation, the method may be performed under an “as a service” delivery model, where the system 110, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned method.

At block 1902, historical utility consumption data corresponding to a utility consumption site is obtained. For example, the optimization system 110 initially obtains historical utility consumption data 1804 corresponding to the utility consumption site 1808 from the data repository 1802, which stores information collected over time from the utility provider 1806. In an example, upon obtaining, the data is stored is as historical utility consumption data 1826 (referred to as consumption data 1826) in the data 1824 of the optimization system 110. This consumption data 1826 may comprise detailed records of energy usage patterns and consumption trends, potentially spanning several years. The consumption data 1826 may include utility consumption patterns showing hourly, daily, weekly, and monthly usage fluctuations, identification of peak demand periods, breakdown of utility consumption by specific equipment or processes, temporal variations such as seasonal changes or differences between weekday and weekend usage, and non-temporal variations like changes in consumption due to equipment upgrades or operational modifications.

At block 1904, utility rate information corresponding to the utility consumption site is obtained from a utility provider. For example, the optimization system 110 obtains utility rate information 1828 corresponding to the utility consumption site from the utility provider 1806. Such information is for understanding the cost implications of energy usage patterns, especially in the context of Time of Day (ToD) or Time of Use (ToU) billing structures. The utility rate information 1828 may include pricing structures and rate schedules that vary based on time of day, season, or consumption levels. It may encompass ToD or ToU rate schedules indicating utility prices for different periods within a 24-hour cycle (such as peak, mid-peak, and off-peak hours), demand charge structures based on peak utility consumption, seasonal variations in rates or structures, and any special tariffs or incentives offered by the utility provider.

At block 1906, the historical utility consumption data is analyzed with respect to the utility rate information to identify energy intensive equipment and/or processes operating during a high-rate period. For example, the optimization engine 114, implemented within the optimization system 110, then analyzes the consumption data 1826 with respect to the utility rate information 1828. In an example, such analysis aims to identify energy-intensive equipment and/or processes operating during high-rate periods, particularly focusing on ToD or ToU pricing impacts. The analysis engine 112 may employ various analytical techniques, including statistical analysis, machine learning algorithms, and pattern recognition methods. It may identify correlations between operational schedules and high energy costs during peak ToD or ToU periods, pinpoint equipment or processes that consistently operate during peak rate hours, and quantify the financial impact of current usage patterns.

At block 1908, based on the analysis, an optimized operation schedule is generated for the utility consumption site. For example, the optimization system 110 generates the optimized operation schedule 1830 for the utility consumption site 1808. This schedule provides detailed recommendations to the utility consumption site 1808 to re-allocate the operation of utility-intensive equipment and processes to lower-rate periods where operationally feasible, taking full advantage of ToD or ToU pricing structures. Further, the optimized schedule may suggest shifting certain production processes to off-peak hours, e.g., adjusting HVAC system operations to pre-cool or pre-heat spaces during lower-rate periods, or coordinating the charging of electric vehicles or battery systems to take advantage of the lowest available ToD or ToU rates.

The optimization system 110 may also incorporate peak shaving strategies into the optimized operation schedule. In an example, the peak shaving involves reducing the amount of energy purchased from the utility during peak demand periods, which often correspond to the highest ToD or ToU rates. This may be achieved by temporarily reducing non-essential loads, utilizing on-site energy storage systems, such as secondary storage source(s) 1810, such as batteries or other energy storage devices during peak periods. In an example, the secondary storage source(s) 1810 are charged using renewable sources of energy, such as wind, solar, etc. To do so, the optimization engine 114 may analyze historical peak demand data and current energy usage to predict when peak demand is likely to occur and automatically implement peak shaving measures to avoid high demand charges. In an example, the optimization engine 114 generates control signals to switch the energy supplied to the equipment and/or processes from utility provider to the energy provided by the secondary storage source(s) 1810, such as batteries.

At block 1910, a control signal is generated to be transmitted to a plurality of on-site equipment to implement the optimized operation schedule. For example, to implement the optimized operational schedule and peak shaving strategies, the optimization system 110 may generate control signals to be transmitted to a plurality of Internet of Things (IoT) equipment installed at the utility consumption site 1808. These signals could automatically adjust equipment settings, start or stop processes, or modify operational parameters to align with the optimized schedule and ToD or ToU rate periods. For example, the optimization system 110 might send signals to smart thermostats to adjust temperature setpoints during peak rate hours, to energy management systems to cycle non-essential equipment for peak shaving, or to production control systems to reschedule energy-intensive processes to off-peak periods.

Further, as part of the peak shaving strategy, the optimization system 110 may also prioritize the usage of secondary energy source(s) 1810 when available to reduce carbon footprint and reliance on non-renewable sources, especially during high ToD or ToU rate periods. In an example, the optimization system 110 may generate signals for the battery storage systems to charge during periods of excess renewable generation or low ToD/ToU rates, and discharge during high-rate grid periods or for peak shaving purposes.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

I/We claim:

1. A system comprising:
a processor; and
an analysis engine coupled to the processor, wherein the analysis engine is to:
obtain a utility bill corresponding to a utility consumption site from a utility bill generation platform;
parse the utility bill to determine values for a plurality of attributes related to utility usage and billing;
analyze the values of the plurality of attributes based on an anomaly detection model, to detect anomalies within the utility bill indicating progression of values of at least one of the plurality of attributes outside normal ranges, wherein the anomaly detection model is trained based on a plurality of training utility bills with each training utility bill comprising a training value corresponding to the plurality of attributes and a corresponding training indicator indicating normal and anomalous status of the training utility bills; and
upon determining the values of the plurality of attributes to be present within corresponding normal ranges, cause to generate a signal to be transmitted to a utility bill resolution engine for resolution of the utility bill.

2. The system as claimed in claim 1, wherein to obtain the utility bill, the analysis engine is to:
monitor a plurality of utility bill notification channel; and
based on monitoring, on detecting generation of the utility bill by a utility provider corresponding to the utility consumption site, extract the utility bill from one or more utility bill generation platform using corresponding utility bill notification channel.

3. The system as claimed in claim 2, wherein the utility bill notification channel is one of a Short Message Service (SMS) notification from a utility provider, an email notification from the utility company, a mobile application push notification from the utility company, a utility company website's bill generation alert, an API notification from a utility provider's billing system, a smart meter data feed indicating completion of a billing cycle, or combination thereof.

4. The system as claimed in claim 2, wherein to extract the utility bill, the analysis engine is to:
access the utility bill generation platform using stored authentication credentials;
identify and resolve security challenges using machine learning-based image recognition techniques;
upon resolving security challenges, receive and input an authentication code for multi-factor verification;
upon successful authentication, navigate over a user interface of the utility bill generation platform to locate the utility bill; and
download the utility bill for subsequent analysis.

5. The system as claimed in claim 1, wherein the plurality of attributes comprises utility consumption data, billing amount, tariff levied details, due date, meter identification number, customer information, billing period, rate schedules, special charges, historical consumption data, payment history, and utility provider information, and the anomalies comprise one of unusual utility consumption patterns, discrepancies between billed amounts and actual consumption data, incorrect tariff levied, billing errors, or combination thereof.

6. The system as claimed in claim 1, wherein to parse the utility bill, the analysis engine is to:
process the utility bill using optical character recognition (OCR) technique to identify text; and
use natural language processing (NLP) to identify and categorize identified text corresponding to the plurality of attributes.

7. The system as claimed in claim 1, wherein once the utility bill is parsed, the analysis engine is to:
analyze the values of the plurality of attributes determined from utility bill against values of attributes extracted from an actual image of a utility meter installed within the utility consumption site to verify correctness of the utility bill;
wherein to extract the values of attributes from the actual image of the utility meter, the analysis engine is to:
process the actual image of the utility meter based on a meter image recognition model, wherein the meter image recognition model is trained based on a plurality of training meter images of utility meter and associated training labels indicating location of presence of various attributes on corresponding training meter image of the utility meter.

8. The system as claimed in claim 7, wherein the analysis engine is to further:
compare the values of the plurality of attributes with respect to the values obtained from a plurality of monitoring devices installed within the utility consumption site, wherein the plurality of monitoring devices comprises IoT devices and sensors; and
based on comparison, determine correctness of the utility bill.

9. The system as claimed in claim 1, wherein to analyze the values of the plurality of attributes, the analysis engine is to further:
analyze the values of the plurality of attributes based on a set of predefined rules by applying logical conditions to determine whether the values of the plurality of attributes are conformant with criteria outlined in the set of predefined rules, wherein the set of predefined rules comprises consumption thresholds for different time periods, expected ranges for billing amounts based on historical data, permissible variations in meter readings between consecutive billing cycles, usage patterns for different customer categories, seasonal adjustments for utility consumption, predefined limits for sudden spikes or drops in usage, expected ratios between different utility services for multi-utility bills, compliance with tariff structures and rate plans, consistency between reported consumption and calculated charges, and alignment with regulatory guidelines for utility billing; and
upon determining that the values of the plurality of attributes fails to meet criteria, generate and escalate an exception report indicating an anomaly to one or more stakeholders for review and resolution.

10. The system as claimed in claim 1, wherein the analysis engine is to further:
maintain an online wallet for each utility consumption site with a prepaid smart meter;
track balance of each online wallet using automated bots;
generate alerts when a wallet balance falls below a predetermined threshold, wherein the predetermined threshold may be a fixed amount or a consumption-based level; and
automatically initiate a wallet recharge process upon detecting a low balance.

11. A method comprising:
obtaining a utility bill corresponding to a utility consumption site from a utility bill generation platform;
parsing the utility bill to determine values for a plurality of attributes related to utility usage and billing;
analyzing the values of the plurality of attributes based on a set of predefined rules by applying logical conditions to determine whether the values of the plurality of attributes are conformant with criteria outlined in the set of predefined rules, wherein the set of predefined rules comprises at least thresholds, expected ranges, and compliance criteria; and
upon determining that the values of the plurality of attributes are conformant with the criteria outlined in the set of predefined rules, generating a signal to be transmitted to a bill resolution engine for resolution of the utility bill.

12. The method as claimed in claim 11, wherein the method comprises:
upon determining that the values of the plurality of attributes fails to conform with criteria outlined within the set of predefined rules, generating an exception report indicating an anomaly to one or more stakeholders for review and resolution, wherein the set of predefined rules comprises consumption thresholds for different time periods, expected ranges for billing amounts based on historical data, permissible variations in meter readings between consecutive billing cycles, usage patterns for different customer categories, seasonal adjustments for utility consumption, predefined limits for sudden spikes or drops in usage, expected ratios between different utility services for multi-utility bills, compliance with tariff structures and rate plans, consistency between reported consumption and calculated charges, and alignment with regulatory guidelines for utility billing.

13. The method as claimed in claim 11, wherein to obtain the utility bill, the method comprises:
monitoring a plurality of utility bill notification channel; and
based on monitoring, upon detecting generation of the utility bill by a utility provider, extracting the utility bill from one or more utility bill generation platform using corresponding utility bill notification channel, wherein the extraction of utility bill comprises:
accessing the utility bill generation platform using stored authentication credentials;
identifying and resolve security challenges using machine learning-based image recognition techniques;
upon resolving security challenges, receiving and inputting an authentication code for multi-factor verification;
upon successful authentication, navigating through the utility bill generation platform to locate the utility bill; and
downloading the utility bill for subsequent analysis.

14. The method as claimed in claim 11, wherein the plurality of attributes comprises utility consumption data, billing amount, tariff levied details, due date, and meter identification number and anomalies comprise one of unusual utility consumption patterns, discrepancies between billed amounts and actual consumption data, incorrect tariff levied, billing errors, or combination thereof.

15. The method as claimed in claim 11, wherein to analyze the values of the plurality of attributes, the method further comprises:
analyzing the values of the plurality of attributes based on an anomaly detection model, to detect anomalies within the utility bill indicating progression of values of at least one of the plurality of attributes outside normal ranges corresponding to that attribute, wherein the anomaly detection model is trained based on a plurality of training utility bills with each training utility bill comprising a plurality of training values of the plurality of attributes and a corresponding indicator indicating normal and anomalous status of the training utility bill; and
upon determining the values of the plurality of attributes to be present within corresponding normal ranges, generating a signal to be transmitted to a bill resolution engine for resolution of the utility bill.

16. A system for optimizing utility consumption and cost in a utility consumption site, comprising:
a processor; and
an optimization engine coupled to the processor, wherein the optimization engine is configured to:
obtain historical utility consumption data corresponding to a utility consumption site, wherein the historical utility consumption data comprises data related to utility consumption patterns and usage pattern corresponding to a plurality of equipment and/or processes;
obtain utility rate information corresponding to the utility consumption site from a utility provider, wherein the utility rate information comprises information comprising pricing structures and rate schedules;
analyze the historical utility consumption data with respect to the utility rate information to identify energy intensive equipment and/or processes operating during a high-rate period, wherein the high-rate period indicates duration of day during which high rates are levied by the utility provider; and
based on the analysis, generate an optimized operation schedule for the utility consumption site indicating details to re-allocate operation of utility intensive equipment and processes to lower-rate periods where operationally feasible.

17. The system as claimed in claim 16, wherein the optimization engine is to further:
generate a control signal to be transmitted to a plurality of Internet of Things (IoT) equipment to implement the optimized operational schedule.

18. The system as claimed in claim 16, wherein the historical utility consumption data comprises energy usage patterns over time, peak demand periods, utility consumption by specific equipment or processes, and temporal or non-temporal variations in utility consumption.

19. The system as claimed in claim 16, wherein the utility rate information comprises time-of-day rate schedules indicating utility prices for different periods within a 24 hour cycle, demand charge structures based on peak utility consumption, and any seasonal variations in rates or structures.

20. The system as claimed in claim 16, wherein the optimized operation schedule comprises details to:
schedule high-energy-consuming operations during off-peak hours to take advantage of lower energy rates; and
prioritize usage of secondary energy sources charged using renewable source of energy when available to reduce carbon footprint and reliance on non-renewable sources.
